(19) United States
(12) Patent Application Publication
(10) Pub. No.: US 2023/0393021 A1
(43) Pub. Date: Dec. 7, 2023

(54) DEVICE AND METHOD FOR MONITORING OPTICAL TRANSMISSION LINE

(71) Applicant: Fujitsu Limited, Kawasaki-shi (JP)

(72) Inventors: KAZUYUKI TAJIMA, Yokosuka (JP); Kyosuke SONE, Kawasaki (JP); Shoichiro ODA, Fuchu (JP)

(73) Assignee: Fujitsu Limited, Kawasaki-shi (JP)

(21) Appl. No.: 18/326,091

(22) Filed: May 31, 2023

(30) Foreign Application Priority Data
Jun. 3, 2022 (JP) 2022-090641
Feb. 3, 2023 (JP) 2023-014962

(51) Int. Cl. G01M 11/00; H04B 10/079

(52) U.S. Cl. CPC G01M 11/338; H04B 10/07951

(57) ABSTRACT

Monitoring device monitors an optical transmission line by using electric field information signal indicating an electric field of received optical signal. The monitoring device includes a processor. The processor sequentially compensates for first chromatic dispersion among chromatic dispersion of the optical fiber transmission line, nonlinear distortion of the optical fiber transmission line, and remaining chromatic dispersion among the chromatic dispersion in the electric field information signal to generate a reference signal indicating the electric field of the optical signal in the transmitter node. The processor detects, in the electric field information signal, second distortion different from the nonlinear distortion. The processor processes the reference signal based on the second distortion to generate a second reference signal. The processor calculates, based on a correlation between the compensated electric field information signal and the second reference signal, optical power corresponding to the first chromatic dispersion.

### CROSS-REFERENCE TO RELATED APPLICATIONS

This application is based upon and claims the benefit of priority of the prior Japanese Patent Application No. 2022-090641, filed on Jun. 3, 2022 and the prior Japanese Patent Application No. 2023-014962, filed on Feb. 3, 2023, the entire contents of which are incorporated herein by reference.

### FIELD

The embodiments discussed herein are related to a device and a method for monitoring an optical fiber transmission line.

### BACKGROUND

An optical signal propagating through an optical fiber transmission line changes with respect to a distance from a transmitting station. In addition, in the configuration in which a relay station is provided on an optical fiber transmission line, the optical signal is amplified in the relay station.

In order to manage the quality of an optical transmission system, it is preferable that the optical power at an arbitrary position on the optical fiber transmission line can be measured. On the other hand, in many cases, it is required to reduce the management cost of the optical transmission system. Therefore, a method of measuring optical power at an arbitrary position on an optical fiber transmission line based on a received optical signal in a receiving station has been proposed (for example, Japanese Laid-open Patent Publication No. 2018-133725).

In a large-scale optical network, an optical signal transmitted from a transmitting station to a receiving station passes through one or a plurality of optical nodes. On the other hand, wavelength division multiplexing (WDM) has been put into practical use as one of techniques for achieving large-capacity optical communication. The WDM can multiplex a plurality of wavelength channels. Here, in a WDM transmission system, a reconfigurable optical add-drop multiplexer (ROADM) is provided on each optical node. The ROADM can branch an optical signal of a desired wavelength from a WDM signal, and insert the optical signal into an empty channel of the WDM signal.

As described above, in a large-scale optical network employing WDM, an optical signal transmitted from a transmitting station to a receiving station passes through one or a plurality of ROADMs. However, when the optical signal passes through each ROADM, the quality of the optical signal is deteriorated. Specifically, an optical signal may be deteriorated due to pass band narrowing (PBN). Thus, in an optical network in which one or a plurality of optical nodes is provided between a transmitting station and a receiving station, optical power at an arbitrary position on an optical fiber transmission line may not be accurately measured based on a received optical signal. Additionally, when distortion occurs in the optical signal due to other factors, the optical power may not be accurately measured. For example, when I/Q distortion occurs at a transmitting station, optical power at an arbitrary position on an optical fiber transmission line may not be accurately measured based on a received optical signal.

### SUMMARY

According to an aspect of the embodiments, an optical transmission line monitoring device monitors an optical fiber transmission line by using an electric field information signal indicating an electric field of an optical signal received via the optical fiber transmission line by a second node in an optical transmission system in which the optical signal is transmitted from a first node to the second node via the optical fiber transmission line. The optical transmission line monitoring device includes a processor. The processor performs a first process to compensate for, in the electric field information signal, a first chromatic dispersion among a chromatic dispersion of the optical fiber transmission line. The processor performs a second process to compensate for, in an output signal of the first process, a nonlinear distortion of the optical fiber transmission line. The processor performs a third process to compensate for, in an output signal of the second process, a remaining chromatic dispersion among the chromatic dispersion of the optical fiber transmission line. The processor generates, based on the electric field information signal, a reference signal indicating the electric field of the optical signal in the first node. The processor detects, in the electric field information signal, a second distortion different from the nonlinear distortion compensated for in the second process. The processor processes the reference signal based on the second distortion to generate a second reference signal. The processor calculates, based on a correlation between an output signal of the third process and the second reference signal, an optical power corresponding to the first chromatic dispersion.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates an example of a method of measuring power of an optical signal at an arbitrary position on an optical fiber transmission line;

FIG. 2 illustrates an example of a function of a digital signal processor;

FIG. 3 illustrates an example of changes in power of an optical signal and chromatic dispersion;

FIG. 4 is a flowchart illustrating an example of a process of measuring power of an optical signal at a plurality of positions on an optical fiber transmission line;

FIG. 5 illustrates an example of an optical transmission system and a power profile;

FIGS. 6A to 6C illustrate an example of a method of generating a power profile;

FIGS. 7A and 7B are diagrams describing the influence of pass band narrowing;

FIG. 8 illustrates an example of an optical transmission line monitoring device according to an embodiment of the present invention;

FIG. 9 illustrates an example of a process of a spectrum shaper;

FIGS. 10 and 11 illustrate variations of the optical transmission line monitoring device;

FIG. 12 illustrates an example of a spectrum shaper provided in an optical transmission line monitoring device according to a first embodiment of the present invention;

FIG. 13 is a flowchart illustrating an example of a process of the optical transmission line monitoring device according to the first embodiment of the present invention;

FIG. 14 illustrates an example of a spectrum shaper provided in an optical transmission line monitoring device according to a second embodiment of the present invention;

FIG. 15 is a flowchart illustrating an example of a process of the optical transmission line monitoring device according to the second embodiment of the present invention;

FIG. 16 illustrates an example of a spectrum shaper provided in an optical transmission line monitoring device according to a third embodiment of the present invention;

FIG. 17 illustrates an example of an array of a monitor signal and a reference signal;

FIG. 18 is a flowchart illustrating an example of a method of configuring a filter in the third embodiment;

FIG. 19 illustrates an example of a method of adjusting a pass band of a filter;

FIG. 20 is a flowchart illustrating an example of a process of the optical transmission line monitoring device according to the third embodiment of the present invention;

FIG. 21 illustrates an example of an optical transmission line monitoring device according to a fourth embodiment of the present invention;

FIG. 22 illustrates an example of a method of detecting a span;

FIG. 23 is a flowchart illustrating an example of a process of the optical transmission line monitoring device according to the fourth embodiment;

FIGS. 24A to 24D illustrate an example of a method of estimating a fiber type;

FIGS. 25A to 25C illustrate an example of a power profile of an optical fiber transmission line;

FIG. 26 illustrates RMS values of noise components of a power profile;

FIG. 27 illustrates an example of an optical transmission line monitoring device that compensates for arbitrary distortion and creates a power profile;

FIG. 28 illustrates another example of an optical transmission line monitoring device that compensates for arbitrary distortion and creates a power profile;

FIG. 29 illustrates a variation of the configuration illustrated in FIG. 28;

FIGS. 30A to 30C illustrate an example of I/Q distortion;

FIG. 31 illustrates an example of an optical transmission line monitoring device according to a fifth embodiment of the present invention;

FIG. 32 illustrates a configuration example of an I/Q distortion detector and an I/Q distortion compensator;

FIG. 33 is a flowchart illustrating an example of a process of the optical transmission line monitoring device according to the fifth embodiment;

FIG. 34 illustrates an example of an optical transmission line monitoring device according to a sixth embodiment of the present invention;

FIG. 35 illustrates a configuration example of an I/Q distortion detector and an I/Q distortion processor;

FIG. 36 is a flowchart illustrating an example of a process of the optical transmission line monitoring device according to the sixth embodiment; and

FIG. 37 illustrates an example of an optical transmission line monitoring device according to a seventh embodiment of the present invention.

### DESCRIPTION OF EMBODIMENTS

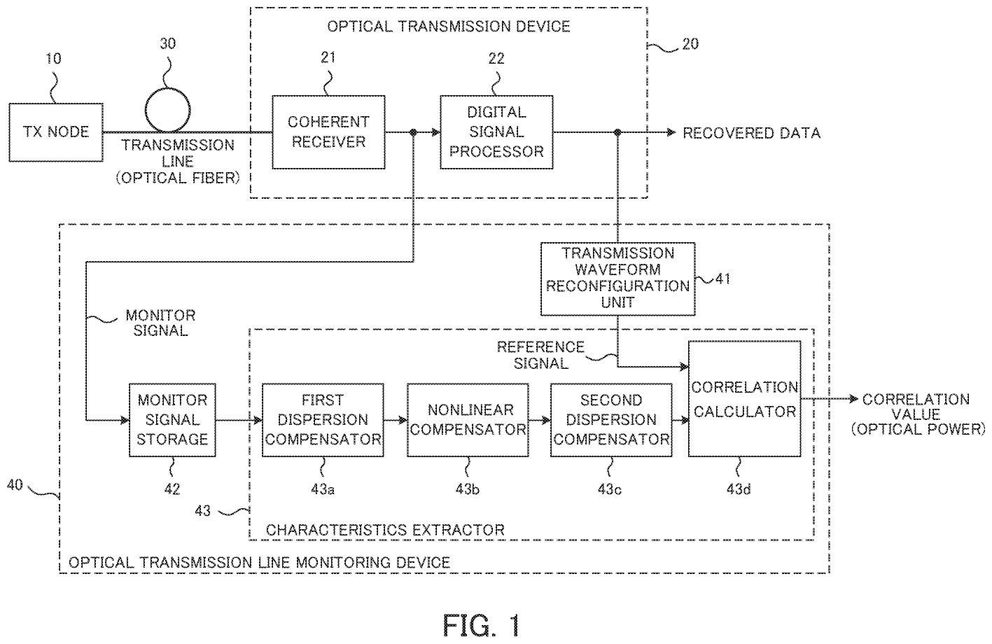

FIG. 1 illustrates an example of a method of measuring power of an optical signal at an arbitrary position on an optical fiber transmission line. In this example, an optical signal transmitted from a transmitter node 10 is transmitted via an optical fiber transmission line 30. An optical transmission device 20 receives the optical signal via the optical fiber transmission line 30. Then, an optical transmission line monitoring device 40 monitors the optical fiber transmission line 30.

The optical transmission device 20 includes a coherent receiver 21 and a digital signal processor 22. Note that the optical transmission device 20 may include other functions or circuits not illustrated in FIG. 1. For example, the optical transmission device 20 may include an analog-to-digital converter (ADC) that converts an output signal of the coherent receiver 21 into a digital signal.

The coherent receiver 21 includes a 90-degree optical hybrid circuit and generates an electric field information signal (or electric field data) indicating an electric field of a received optical signal. The electric field information signal includes an in-phase (I) component and a quadrature (Q) component of the received optical signal. Note that when the optical signal is a polarization multiplexed optical signal, the electric field information signal includes an I component and a Q component of an H-polarized wave and an I component and a Q component of a V-polarized wave.

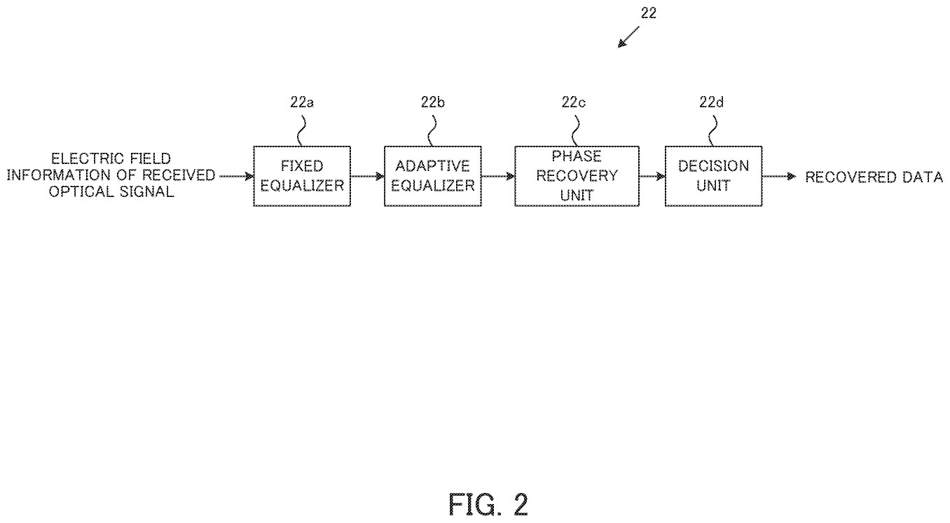

FIG. 2 illustrates an example of a function of the digital signal processor 22. As illustrated in FIG. 2, the digital signal processor 22 includes a fixed equalizer 22a, an adaptive equalizer 22b, a phase recovery unit 22c, and a decision unit 22d. The digital signal processor 22 processes the electric field information of the received optical signal.

The fixed equalizer 22a compensates for chromatic dispersion of the optical fiber transmission line 30. It is assumed that the chromatic dispersion of the optical fiber transmission line 30 is known. The adaptive equalizer 22b adaptively equalizes the output signal of the fixed equalizer 22a. For example, the adaptive equalizer 22b can compensate for residual dispersion. Note that when the received optical signal is a polarization multiplexed optical signal, the adaptive equalizer 22b has a function of separating the received optical signal for each polarized wave. The phase recovery unit 22c compensates for the phase offset between the transmitter node 10 and the optical transmission device and estimates the phase of the optical signal transmitted from the transmitter node 10. That is, for each symbol, a signal point on the constellation is estimated. The decision unit 22d recovers transmission data based on constellation information (phase and amplitude) output from the phase recovery unit 22c.

Note that the digital signal processor 22 may have a frequency correction function between the adaptive equalizer 22b and the phase recovery unit 22c. In this case, the frequency correction function compensates for the frequency offset between the light source of the transmitter node 10 and the local light source included in the optical transmission device 20. In addition, the digital signal processor 22 may have a function of correcting an error in the data recovered by the decision unit 22d.

The optical transmission line monitoring device 40 includes a transmission waveform reconfiguration unit 41, a monitor signal storage 42, and a characteristics extractor 43. Note that the optical transmission line monitoring device 40 may have other circuits or functions not illustrated in FIG. 1. The optical transmission line monitoring device 40 is achieved by, for example, a computer including a processor and a memory. Alternatively, the optical transmission line monitoring device 40 may be achieved by a signal processing circuit that processes a digital signal.

The transmission waveform reconfiguration unit 41 maps the transmission data recovered by the digital signal processor 22 on the constellation and generate an electric field information signal. Here, the mapping by the transmission waveform reconfiguration unit 41 is substantially the same as mapping performed in the transmitter node 10. Thus, the electric field information signal generated by the transmission waveform reconfiguration unit 41 is substantially the same as the electric field information signal for generating the optical signal at the transmitter node 10. That is, the output signal of the transmission waveform reconfiguration unit 41 indicates the electric field of the optical signal at the transmitter node 10. Note that, in the following description, the output signal (that is, the electric field information signal for generating the optical signal at the transmitter node 10) of the transmission waveform reconfiguration unit 41 may be referred to as a “reference signal”. In addition, the transmission waveform reconfiguration unit 41 is an example of a reference signal generator that generates a reference signal.

The monitor signal storage 42 stores the electric field information signal indicating the electric field of the optical signal received by the optical transmission device 20. In the following description, the electric field information signal indicating the electric field of the optical signal received by the optical transmission device may be referred to as a “monitor signal”. The monitor signal storage 42 stores the monitor signal indicating the electric field of the optical signal received by the optical transmission device 20. Note that, in FIG. 1, the input signal of the digital signal processor 22 is stored in the monitor signal storage 42 as a monitor signal, but the embodiments of the present invention are not limited to this configuration. For example, the output signal of the fixed equalizer 22a, the adaptive equalizer 22b, or the phase recovery unit 22c may be stored in the monitor signal storage 42 as a monitor signal.

The characteristics extractor 43 includes a first dispersion compensator 43a, a nonlinear compensator 43b, a second dispersion compensator 43c, and a correlation calculator 43d, and detects characteristics of the optical fiber transmission line 30 based on the electric field information signal indicating the electric field of the optical signal received by the optical transmission device 20. The first dispersion compensator 43a compensates for a part of chromatic dispersion (hereinafter, first chromatic dispersion) of the chromatic dispersion of the optical fiber transmission line 30 in the electric field information signal (that is, the monitor signal) indicating the electric field of the optical signal received by the optical transmission device 20. The nonlinear compensator 43b compensates for nonlinear distortion (that is, self-phase modulation) of the optical fiber transmission line 30 in the output signal of the first dispersion compensator 43a. The second dispersion compensator 43c compensates for the remaining chromatic dispersion (hereinafter, second chromatic dispersion) of the chromatic dispersion of the optical fiber transmission line 30 in the output signal of the nonlinear compensator 43b. The correlation calculator 43d calculates a correlation between the output signal of the second dispersion compensator 43c and the output signal (that is, the reference signal) of the transmission waveform reconfiguration unit 41. Here, as described above, the reference signal indicates the electric field of the optical signal at the transmitter node 10. That is, the correlation calculator 43d calculates a correlation between the electric field information signal in which the chromatic dispersion and the nonlinear distortion are compensated for and the electric field information signal indicating the electric field of the optical signal at the transmitter node 10. Note that the output signal of the second dispersion compensator 43c and the output signal of the transmission waveform reconfiguration unit 41 are preferably each appropriately normalized.

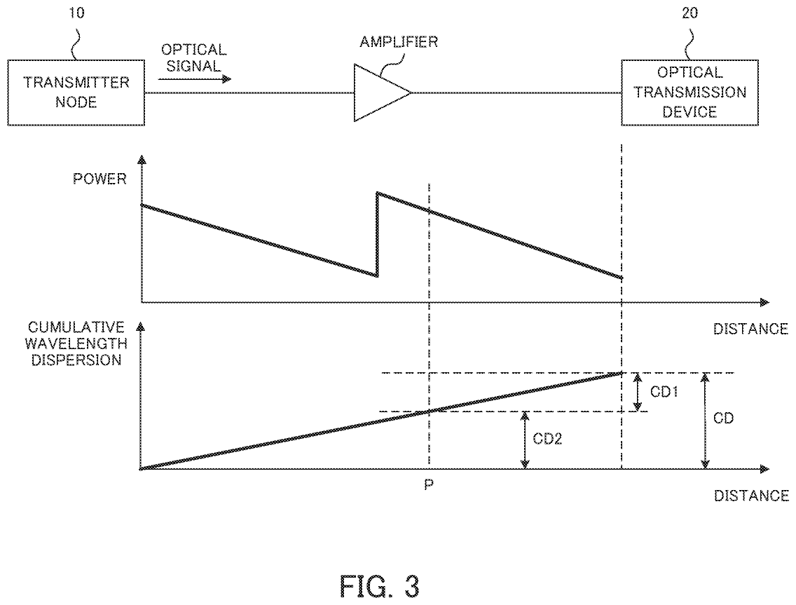

The correlation value calculated by the characteristics extractor 43 indicates the power of the optical signal transmitted via the optical fiber transmission line 30. That is, the optical transmission line monitoring device 40 can measure the power of the optical signal transmitted via the optical fiber transmission line 30 by calculating the correlation value. Here, the relationship between the correlation value and the power of the optical signal will be described with reference to FIG. 3.

FIG. 3 illustrates an example of changes in power of an optical signal and chromatic dispersion. In this example, the optical signal is transmitted from the transmitter node 10 to the optical transmission device 20. An optical amplifier is provided on the optical fiber transmission line 30.

The power of the optical signal is attenuated with increasing a distance from the transmitter node 10. Then, the optical signal is amplified by the optical amplifier. Thereafter, the power of the optical signal is attenuated with increasing a distance from the optical amplifier. The cumulative chromatic dispersion added to the optical signal increases in proportion to the distance from the transmitter node 10. Note that “CD” illustrated in FIG. 3 indicates the total chromatic dispersion of the optical fiber transmission line 30 between the transmitter node 10 and the optical transmission device 20.

It is assumed that the optical transmission line monitoring device 40 measures the power of the optical signal at a position P illustrated in FIG. 3. Note that the chromatic dispersion of the optical fiber transmission line between the optical transmission device 20 and the position P is CD1. The chromatic dispersion of the optical fiber transmission line 30 between the transmitter node 10 and the position P is CD2. Thus, the sum of CD1 and CD2 is CD.

As described above, the characteristics extractor 43 compensates for chromatic dispersion and nonlinear distortion. That is, the first dispersion compensator 43a compensates for the chromatic dispersion CD1 in the electric field information signal (that is, the monitor signal) indicating the received optical signal. The nonlinear compensator 43b compensates for nonlinear distortion in the output signal of the first dispersion compensator 43a. At this time, the nonlinear compensator 43b compensates for a specified amount of nonlinear distortion. Then, the second dispersion compensator 43c compensates for the chromatic dispersion CD2 in the output signal of the nonlinear compensator 43b.

Here, the intensity of the nonlinear distortion generated in the optical fiber transmission line 30 depends on the power of the optical signal. Specifically, the larger the power of the optical signal, the larger the nonlinear distortion. In this example, the nonlinear compensator 43b is designed to compensate for the nonlinear distortion generated when the power of the optical signal is sufficiently large. As an example, although not particularly limited, the nonlinear compensator 43b is designed to compensate for the nonlinear distortion generated in the output optical power of the transmitter node 10.

Meanwhile, the correlation value calculated by the correlation calculator 43d indicates a correlation between the electric field information signal in which the chromatic dispersion and the nonlinear distortion are compensated by the characteristics extractor 43 and the electric field information signal indicating the electric field of the optical signal at the transmitter node 10. Thus, when the nonlinear distortion is appropriately compensated for in the nonlinear compensator 43b, the correlation value calculated by the correlation calculator 43d increases.

Specifically, when the power of the optical signal at the position P is large, the amount of nonlinear distortion at the position P increases, and the difference between the amount of nonlinear distortion at the position P and the amount of nonlinear distortion compensated for by the nonlinear compensator 43b decreases. As a result, the nonlinear distortion is appropriately compensated for by the nonlinear compensator 43b, and the difference between the output signal of the second dispersion compensator 43c and the electric field information signal at the transmitter node 10 decreases, so that the correlation value calculated by the correlation calculator 43d increases. On the other hand, when the power of the optical signal at the position P is small, the amount of nonlinear distortion at the position P decreases, and the difference between the amount of nonlinear distortion at the position P and the amount of nonlinear distortion compensated for by the nonlinear compensator 43b increases. As a result, the nonlinear distortion is not appropriately compensated for by the nonlinear compensator 43b, and the difference between the output signal of the second dispersion compensator 43c and the electric field information signal at the transmitter node 10 increases, so that the correlation value calculated by the correlation calculator 43d decreases. In other words, the correlation value increases when the power of the optical signal at the position P is large, and the correlation value decreases when the power of the optical signal at the position P is small. Accordingly, the correlation value calculated by the characteristics extractor 43 substantially indicates the power of the optical signal at a specified position (in FIG. 3, the position P) on the optical fiber transmission line.

In addition, the position P illustrated in FIG. 3 is designated by the chromatic dispersion CD1 or the chromatic dispersion CD2 (or a combination of the chromatic dispersion CD1 and the chromatic dispersion CD2). Thus, the characteristics extractor 43 can measure the power of the optical signal at a desired position on the optical fiber transmission line by changing the chromatic dispersion CD1 or the chromatic dispersion CD2 (or a combination of the chromatic dispersion CD1 and the chromatic dispersion CD2) for the electric field information signal indicating the electric field of the received optical signal.

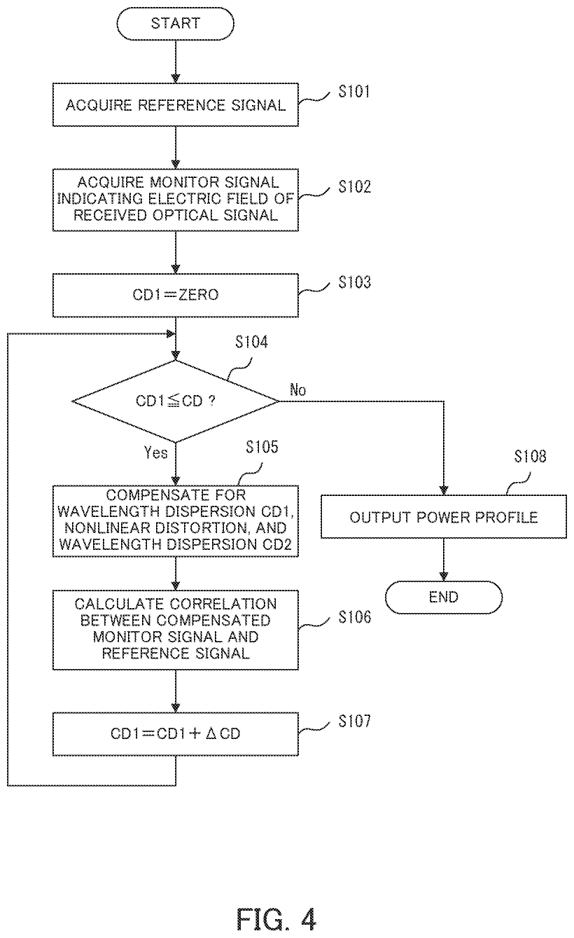

FIG. 4 is a flowchart illustrating an example of a process of measuring power of an optical signal at a plurality of positions on an optical fiber transmission line. This process is executed when the optical transmission device 20 receives the optical signal transmitted from the transmitter node 10 via the optical fiber transmission line 30.

In S101, the characteristics extractor 43 acquires the electric field information signal (that is, the reference signal) generated by the transmission waveform reconfiguration unit 41. The reference signal indicates the electric field of the optical signal at the transmitter node 10. In S102, the characteristics extractor 43 acquires the monitor signal indicating the electric field information of the received optical signal. It is assumed that the monitor signal is generated by the coherent receiver 21 or the digital signal processor 22 and stored in the monitor signal storage 42.

In S103, the characteristics extractor 43 initializes the chromatic dispersion CD1 to “0”. The value of the chromatic dispersion CD1 corresponds to a transmission distance from the optical transmission device 20. In addition, the chromatic dispersion CD2 is calculated from “CD1+CD2=CD”. CD indicates the total chromatic dispersion of the optical fiber transmission line between the transmitter node 10 and the optical transmission device and it is assumed that the value is known. In S104, the characteristics extractor 43 determines whether the chromatic dispersion CD1 is equal to or less than CD. Then, when the chromatic dispersion CD1 is equal to or less than CD, the process of the characteristics extractor 43 proceeds to S105.

In S105, the characteristics extractor 43 sequentially executes a compensation for the chromatic dispersion CD1, a nonlinear compensation, and a compensation for the chromatic dispersion CD2 for the monitor signal indicating the electric field information of the received optical signal. In S106, the characteristics extractor 43 calculates a correlation between the monitor signal compensated for in S105 and the reference signal acquired in S101.

In S107, the characteristics extractor 43 adds ΔCD to the chromatic dispersion CD1. ΔCD is preferably sufficiently small with respect to the total chromatic dispersion CD. Thereafter, the process of the characteristics extractor 43 returns to S104. That is, in S104 to S107, the characteristics extractor 43 calculates correlation values while increasing the chromatic dispersion CD1 by ΔCD until the chromatic dispersion CD1 becomes larger than CD. Here, the value of the chromatic dispersion CD1 corresponds to a transmission distance from the optical transmission device 20. Thus, the process of increasing the chromatic dispersion CD1 by ΔCD is equivalent to the process of shifting the position on the optical fiber transmission line by a distance corresponding to ΔCD. Accordingly, the characteristics extractor 43 can obtain correlation values at a plurality of positions on the optical fiber transmission line by repeatedly executing the processing of S104 to S107.

When the chromatic dispersion CD1 becomes larger than CD, in S108, the characteristics extractor 43 outputs the correlation values calculated in S104 to S107. Here, the correlation value substantially indicates the power of the optical signal at a specified position on the optical fiber transmission line corresponding to the combination of the chromatic dispersions CD1 and CD2. That is, the characteristics extractor 43 can detect the power of the optical signal at a plurality of positions on the optical fiber transmission line. Note that, in the following description, information indicating the power of the optical signal at a plurality of positions on the optical fiber transmission line may be referred to as a “power profile”. As described above, the optical transmission line monitoring device 40 can measure the power of the optical signal at a desired position on the optical fiber transmission line and create the power profile of the optical fiber transmission line.

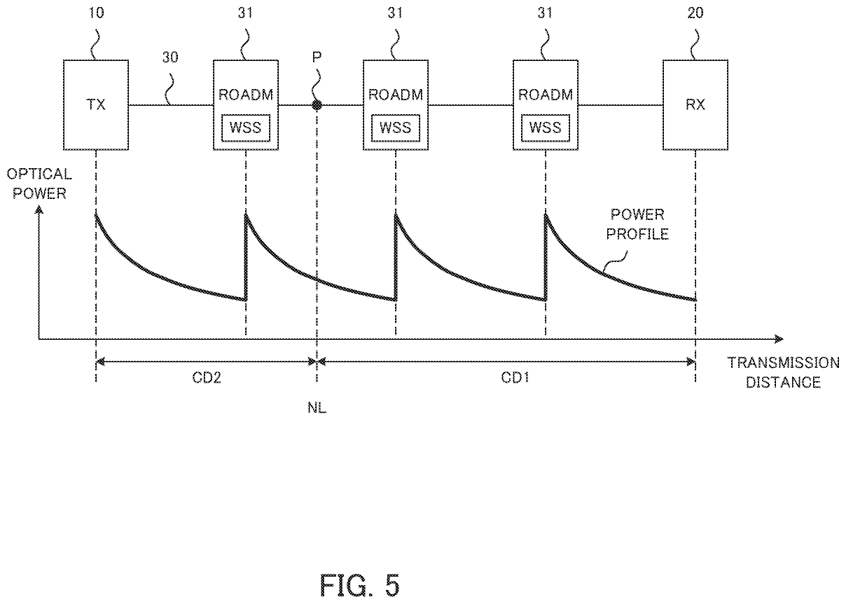

FIG. 5 illustrates an example of an optical transmission system and a power profile. In this example, a WDM signal is transmitted from the transmitter node (TX) 10 to the optical transmission device (RX) 20 via the optical fiber transmission line 30. The WDM signal transmits a plurality of wavelength channels. In addition, ROADMs 31 are provided between the transmitter node 10 and the optical transmission device 20. Each ROADM 31 includes a wavelength selective switch (WSS).

The WSS can process each wavelength channel of the WDM signal. For example, the WSS can branch an optical signal of a designated wavelength channel from the WDM signal received by the ROADM 31. In addition, the WSS can insert an optical signal into an empty channel of the WDM signal. Further, the WSS outputs the optical signal of the wavelength channel passing through the ROADM 31 toward a destination node. In this case, the WSS works as a bandpass filter for the optical signal of the wavelength channel passing through the ROADM 31.

In the optical transmission system having the above configuration, the optical transmission line monitoring device 40 generates the power profile of the optical fiber transmission line 30. At this time, the optical transmission line monitoring device 40 generates the power profile using the electric field information indicating the optical signal received by the optical transmission device 20. For example, when measuring the optical power at a point P, the optical transmission line monitoring device 40 sequentially compensates for the chromatic dispersion CD1, the nonlinear distortion NL, and the chromatic dispersion CD2 in the monitor signal indicating the optical signal received by the optical transmission device 20. Then, the optical power at the point P is measured by calculating the correlation between the compensated monitor signal and the reference signal. The power profile is obtained by calculating the correlation for a plurality of positions between the transmitter node 10 and the optical transmission device 20. Note that, in the following description, the monitor signal in which the chromatic dispersion and the nonlinear distortion are compensated for may be referred to as a “monitor signal” without being distinguished from the pre-compensation monitor signal.

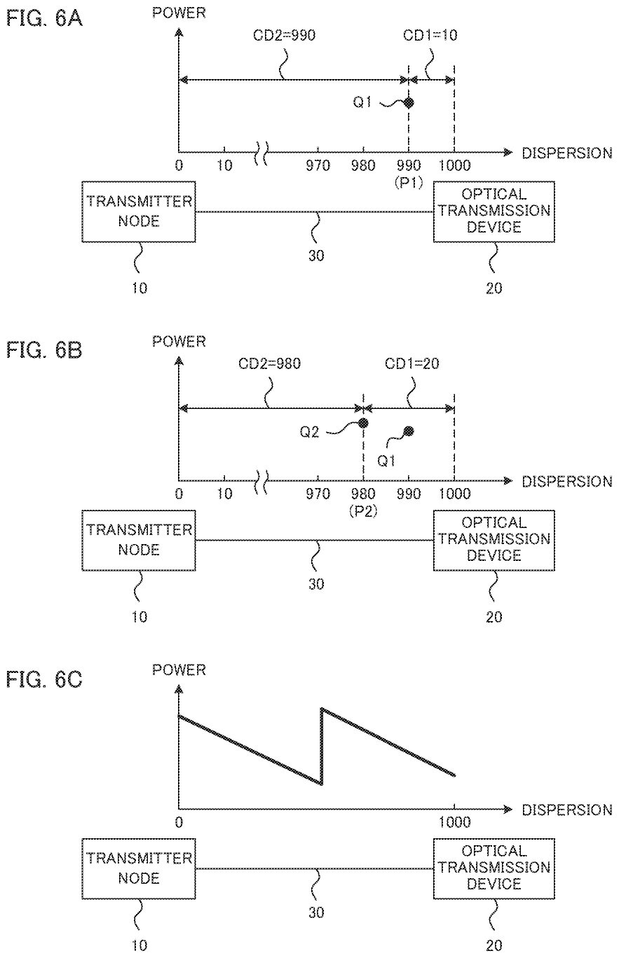

FIGS. 6A to 6C illustrate an example of a method of generating a power profile. In this example, the total dispersion amount of the optical fiber transmission line 30 between the transmitter node 10 and the optical transmission device 20 is 1000 ps/nm. The characteristics extractor 43 acquires a received electric field information signal (that is, the monitor signal) indicating the electric field of the optical signal received by the optical transmission device 20. In addition, the characteristics extractor 43 acquires the reference signal indicating the electric field information for generating the optical signal at the transmitter node 10. The reference signal is generated by the transmission waveform reconfiguration unit 41 illustrated in FIG. 1. ΔCD used in the flowchart illustrated in FIG. 4 is 10 ps/nm.

The characteristics extractor 43 sets “CD1=10” and “CD2=990”. The first dispersion compensator 43a compensates for the dispersion of 10 ps/nm in the monitor signal. The nonlinear compensator 43b compensates for nonlinear distortion in the output signal of the first dispersion compensator 43a. The second dispersion compensator 43c compensates for the dispersion of 990 ps/nm in the output signal of the nonlinear compensator 43b. Then, the correlation calculator 43d calculates a correlation between the reference signal and the output signal of the second dispersion compensator 43c. Here, this correlation value indicates the power of the optical signal at a position P1 illustrated in FIG. 6A. The position P1 corresponds to a position advanced from the optical transmission device 20 toward the transmitter node 10 by a transmission distance corresponding to the dispersion of 10 ps/nm. In this example, the power of the optical signal at the position P1 is Q1.

Next, the characteristics extractor 43 sets “CD1=20” and “CD2=980”. The first dispersion compensator 43a compensates for the dispersion of 20 ps/nm in the monitor signal. The nonlinear compensator 43b compensates for nonlinear distortion in the output signal of the first dispersion compensator 43a. The second dispersion compensator 43c compensates for the dispersion of 980 ps/nm in the output signal of the nonlinear compensator 43b. Then, the correlation calculator 43d calculates a correlation between the reference signal and the output signal of the second dispersion compensator 43c. Here, this correlation value indicates the power of the optical signal at a position P2 illustrated in FIG. 6B. The position P2 corresponds to a position advanced from the optical transmission device 20 toward the transmitter node 10 by a transmission distance corresponding to the dispersion of 20 ps/nm. In this example, the power of the optical signal at the position P2 is Q2.

Similarly, the characteristics extractor 43 calculates the optical power with respect to each dispersion amount while shifting the dispersion amounts compensated for by the first dispersion compensator 43a and the second dispersion compensator 43c by ΔCD. As a result, as illustrated in FIG. 6C, the power profile indicating the relationship between the dispersion amount corresponding to the transmission distance from the optical transmission device 20 and the power of the optical signal is generated.

As described above, the optical transmission line monitoring device 40 can measure the power of the optical signal at a desired position on the optical fiber transmission line 30 by calculating the correlation between the monitor signal and the reference signal. Here, the reference signal indicates the electric field information for generating the optical signal at the transmitter node and is generated by the transmission waveform reconfiguration unit 41 based on the transmission data recovered by the digital signal processor 22. Thus, the reference signal is not substantially affected by the optical fiber transmission line 30. That is, the spectrum of the reference signal is substantially the same as the spectrum of the optical signal transmitted from the transmitter node 10.

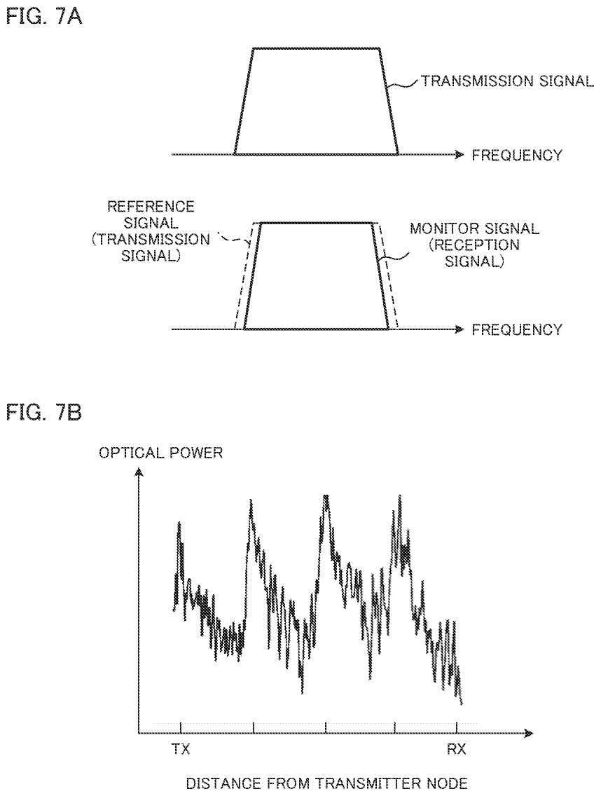

On the other hand, the monitor signal indicates the electric field information of the optical signal received by the optical transmission device 20 via the optical fiber transmission line 30. Thus, the monitor signal is affected by the optical fiber transmission line 30. For example, when an optical signal passes through the ROADM 31, pass band narrowing (PBN) occurs due to filtering by the WSS. Therefore, as illustrated in FIG. 7A, the width of the spectrum of the monitor signal is narrower than the spectrum of the optical signal transmitted from the transmitter node That is, the width of the spectrum of the monitor signal is narrower than the spectrum of the reference signal. As a result, an error in correlation calculation between the monitor signal and the reference signal increases, and the accuracy of the power profile deteriorates. For example, as illustrated in FIG. 7B, a large noise may be added to the power profile generated by the characteristics extractor 43. In this case, the optical power of the optical fiber transmission line cannot be accurately detected.

Note that the noise component can be suppressed by acquiring the electric field information of the received optical signal at a plurality of different timings to generate a plurality of power profiles and averaging the power profiles. However, in this case, a calculation amount and/or a calculation time for obtaining an accurate power profile are increased. Therefore, the embodiments of the present invention provide a method of generating an accurate power profile with a small calculation amount and/or calculation time.

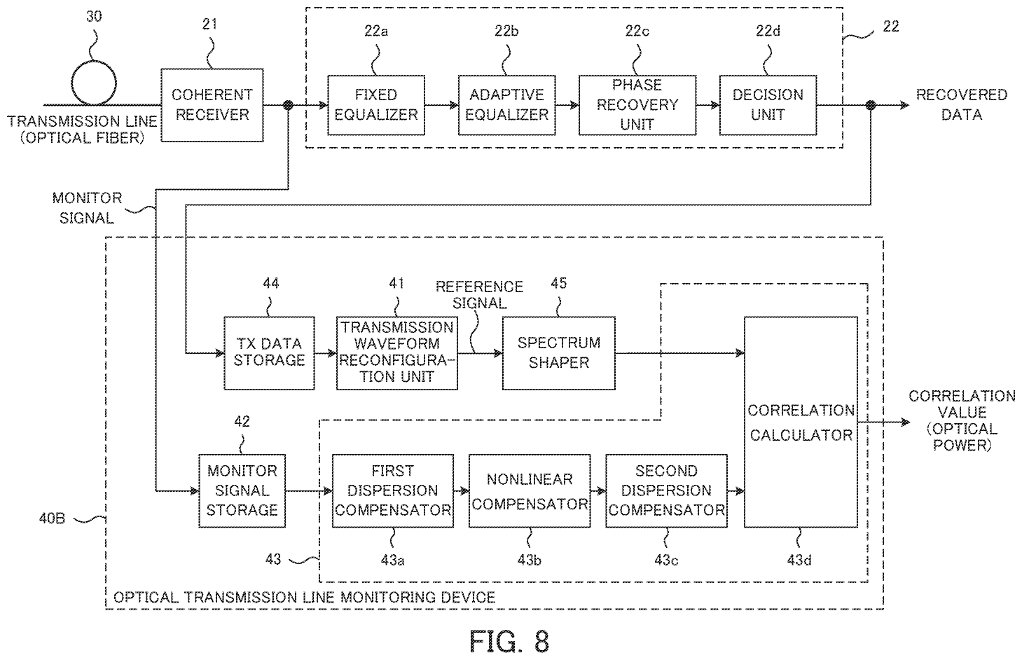

FIG. 8 illustrates an example of an optical transmission line monitoring device according to an embodiment of the present invention. An optical transmission line monitoring device 40B according to an embodiment of the present invention is used in an optical transmission system in which an optical signal is transmitted from a first node to a second node via an optical fiber transmission line. The first node, the second node, and the optical fiber transmission line correspond to the transmitter node 10, the optical transmission device 20, and the optical fiber transmission line 30, respectively, in the example illustrated in FIG. 1. Then, the optical transmission line monitoring device 40B monitors the optical fiber transmission line 30 using a received electric field information signal indicating the electric field of the optical signal received by the optical transmission device via the optical fiber transmission line 30.

The optical transmission device 20 includes the coherent receiver 21 and the digital signal processor 22 as described with reference to FIG. 1. In addition, as described with reference to FIG. 2, the digital signal processor 22 includes the fixed equalizer 22a, the adaptive equalizer 22b, the phase recovery unit 22c, and the decision unit 22d. That is, the optical transmission device 20 can recover the data transmitted from the transmitter node 10 by using the electric field information signal indicating the optical signal received via the optical fiber transmission line 30.

As illustrated in FIG. 8, the optical transmission line monitoring device 40B includes a transmission data storage 44, the transmission waveform reconfiguration unit 41, a spectrum shaper 45, a monitor signal storage 42, and the characteristics extractor 43. Note that the monitor signal storage 42 and the characteristics extractor 43 are substantially the same in FIG. 1 and FIG. 8. That is, the monitor signal storage 42 stores the electric field information signal indicating the optical signal received by the optical transmission device 20 as the monitor signal. In this example, the output signal of the coherent receiver 21 (that is, the input signal of the digital signal processor 22) is used as the monitor signal. In addition, the characteristics extractor 43 includes the first dispersion compensator 43a, the nonlinear compensator 43b, the second dispersion compensator 43c, and correlation calculator 43d, and calculates a correlation between the monitor signal and the reference signal. This correlation value indicates the optical power at an arbitrary position of the optical fiber transmission line 30 as described with reference to FIGS. 1 to 6C. Thus, the power profile of the optical fiber transmission line 30 is generated by calculating the correlation while changing the combination of the dispersion amount CD1 compensated for by the first dispersion compensator 43a and the dispersion amount CD2 compensated for by the second dispersion compensator 43c. The optical transmission line monitoring device 40B is implemented by, for example, a computer including a processor and a memory. Alternatively, the optical transmission line monitoring device 40B may be implemented by a signal processing circuit that processes a digital signal.

The transmission data storage 44 stores the transmission data recovered by the digital signal processor 22 of the optical transmission device 20. Note that the transmission data storage 44 is omitted in FIG. 1.

The transmission waveform reconfiguration unit 41 generates the reference signal from the transmission data stored in the transmission data storage 44. Specifically, the transmission waveform reconfiguration unit 41 maps the transmission data on the constellation to generate the electric field information signal. Here, the mapping by the transmission waveform reconfiguration unit 41 is substantially the same as mapping performed in the transmitter node 10. Accordingly, the electric field information signal (that is, the reference signal) generated by the transmission waveform reconfiguration unit 41 is substantially the same as the electric field information signal for generating the optical signal at the transmitter node 10.

The spectrum shaper 45 shapes the spectrum of the reference signal. At this time, the spectrum shaper 45 shapes the spectrum of the reference signal according to the characteristics of the optical fiber transmission line 30. That is, the spectrum shaper 45 shapes the spectrum of the reference signal according to the influence received on the optical fiber transmission line 30 by the optical signal transmitted from the transmitter node 10 to the optical transmission device 20. Specifically, the spectrum of the reference signal is shaped according to the pass band narrowing occurring in the optical fiber transmission line 30.

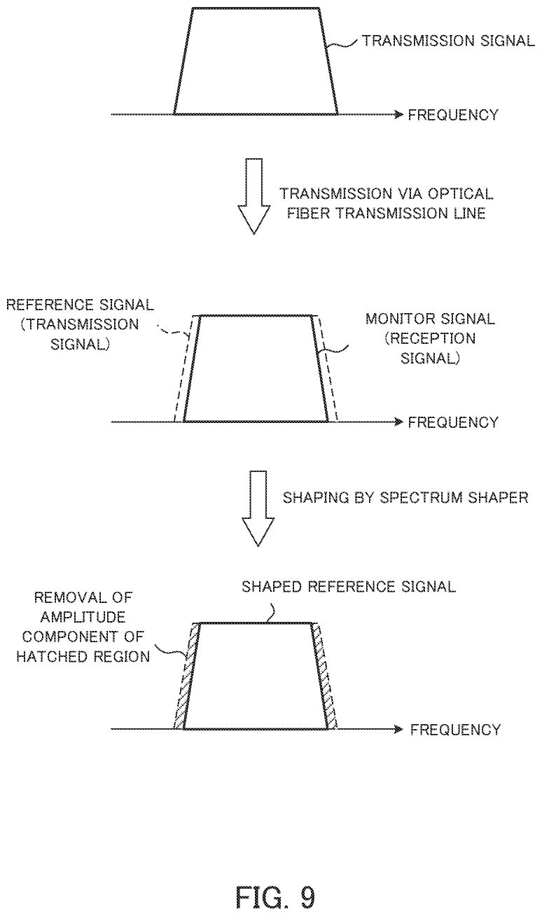

FIG. 9 illustrates an example of a process of the spectrum shaper 45. In this example, it is assumed that one or a plurality of ROADMs is provided on the optical fiber transmission line. That is, pass band narrowing occurs in the optical fiber transmission line.

The optical transmission device 20 recovers the transmission data from the electric field information of the optical signal received via the optical fiber transmission line 30. In addition, the optical transmission device 20 outputs the monitor signal indicating the electric field of the received optical signal. Here, the reference signal is generated based on the recovered transmission data and is therefore not affected by the pass band narrowing. Thus, the spectrum of the reference signal is substantially the same as the spectrum of the transmission signal. On the other hand, the monitor signal indicates the electric field information of the optical signal received by the optical transmission device 20 via the optical fiber transmission line 30, and is therefore affected by the pass band narrowing. Specifically, the width of the spectrum of the monitor signal is narrower than the width of the spectrum of the transmission signal due to the influence of the pass band narrowing. That is, the width of the spectrum of the monitor signal is narrower than the width of the spectrum of the reference signal.

Therefore, the spectrum shaper 45 shapes the spectrum of the reference signal so as to be similar to the spectrum of the monitor signal. Specifically, a part of the amplitude component of the reference signal is removed or reduced so as to reduce the difference between the spectrum of the monitor signal and the spectrum of the reference signal. Preferably, a part of the amplitude component of the reference signal is removed or reduced so that the spectrum of the monitor signal becomes the same as the spectrum of the reference signal. In the example illustrated in FIG. 9, the spectrum shaper 45 removes or reduces hatched components from the amplitude component of the reference signal in the frequency domain. As a result, the shaped reference signal indicates the state of being affected by the pass band narrowing of the optical fiber transmission line 30, similarly to the monitor signal.

The correlation calculator 43d calculates a correlation between the monitor signal in which the chromatic dispersion and the nonlinear distortion are compensated for and the reference signal in which the spectrum is shaped by the spectrum shaper 45. Hence, the optical power at an arbitrary position of the optical fiber transmission line 30 is detected. Here, the shaped reference signal indicates the state of being affected by the pass band narrowing, similarly to the monitor signal. Accordingly, the optical transmission line monitoring device 40B can accurately detect the optical power at an arbitrary position of the optical fiber transmission line 30. That is, the optical transmission line monitoring device 40B can accurately monitor the state of the optical fiber transmission line 30.

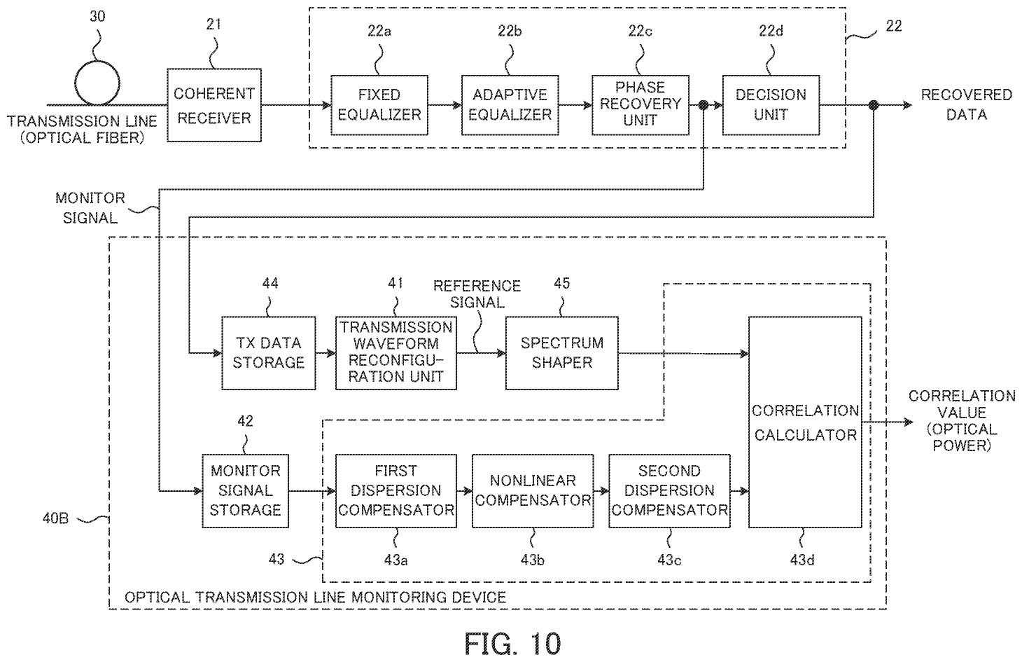

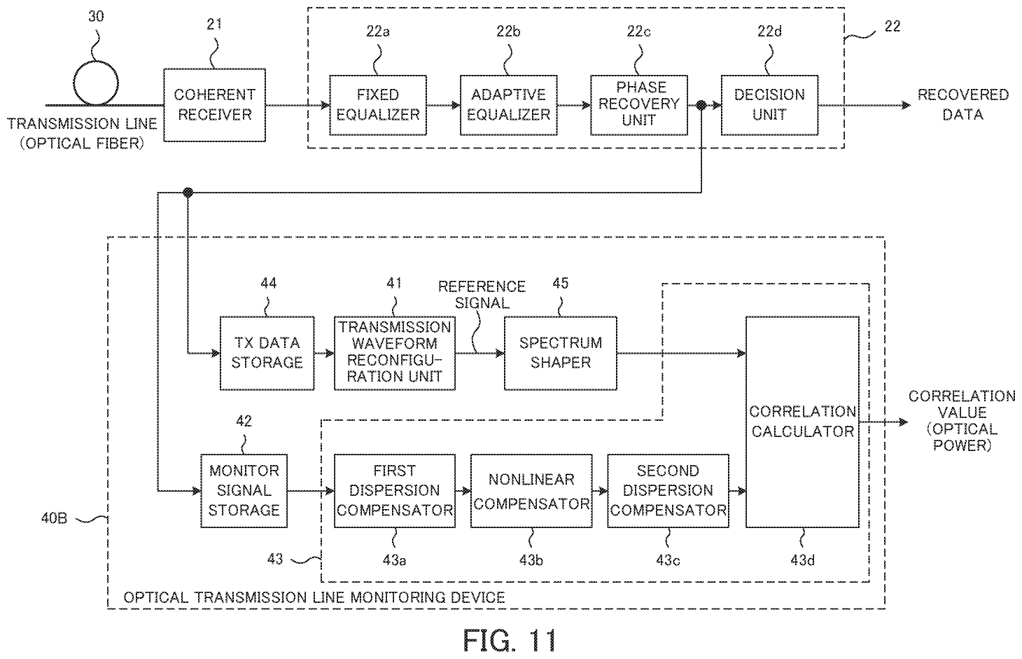

FIGS. 10 and 11 illustrate variations of the optical transmission line monitoring device according to the embodiment of the present invention. In the configuration illustrated in FIG. 10, the optical transmission line monitoring device 40B uses a signal extracted from the digital signal processor 22 as the monitor signal. As an example, an output signal of the phase recovery unit 22c is used as the monitor signal. However, the variation illustrated in FIG. 10 is not limited to this configuration, and a signal before being processed by the phase recovery unit 22c may be used as the monitor signal. In the configuration illustrated in FIG. 11, not only the monitor signal but also the reference signal is generated by using a signal extracted from the digital signal processor 22. As an example, an output signal of the phase recovery unit 22c is used as the reference signal. However, the variation illustrated in FIG. 11 is not limited to this configuration, and a signal before being processed by the phase recovery unit 22c may be used as the reference signal.

In the example illustrated in FIG. 8, 10, or 11, the optical transmission line monitoring device 40B is provided independently of the optical transmission device 20. In this case, the optical transmission line monitoring device 40B acquires the monitor signal and the recovered transmission data from the optical transmission device 20. However, the embodiment of the present invention is not limited to this configuration. For example, the optical transmission line monitoring device 40B may be implemented in the optical transmission device 20.

The optical transmission line monitoring device 40B is achieved by, for example, a central processing unit (CPU), a large-scale integrated circuit (LSI), a field programmable gate array (FPGA), or a combination thereof. Note that, in a case where the optical transmission line monitoring device 40B is achieved by the CPU, the CPU provides the functions of the transmission waveform reconfiguration unit 41, the spectrum shaper 45, and the characteristics extractor 43 by executing a software program.

### First Embodiment

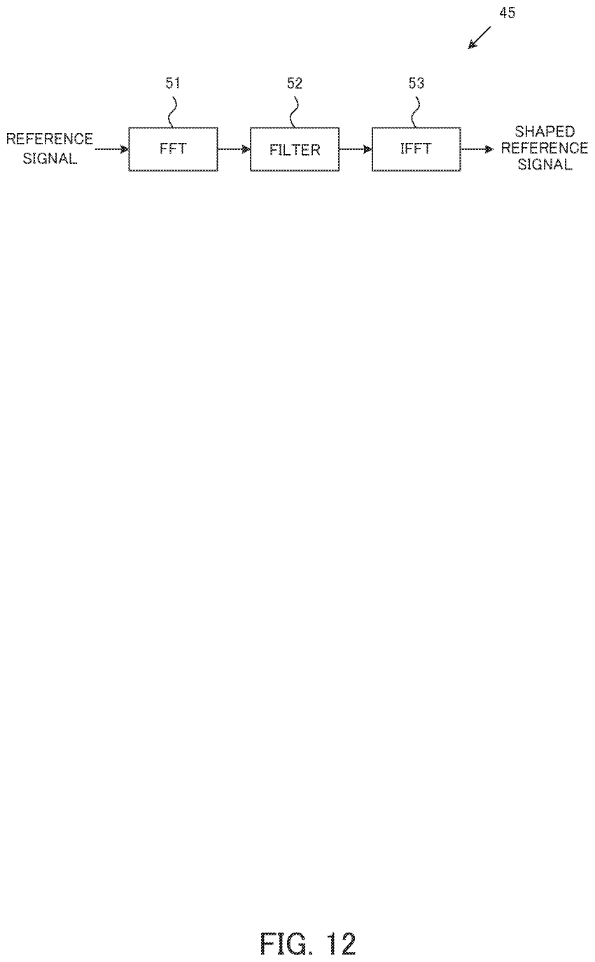

FIG. 12 illustrates an example of a spectrum shaper provided in an optical transmission line monitoring device according to the first embodiment of the present invention. In this example, the spectrum shaper 45 includes a fast Fourier transform (FFT) calculator 51, a filter 52, and an inverse FFT (IFFT) calculator 53.

The FFT calculator 51 generates a reference signal in the frequency domain by executing an FFT calculation on the reference signal. The reference signal in the frequency domain indicates the amplitude or the intensity of the signal for each frequency. That is, the spectrum of the reference signal is obtained by the FFT calculation.

The filter 52 filters the reference signal output from the FFT calculator 51 using filter information prepared in advance. The filter information indicates characteristics of the optical fiber transmission line 30. In this example, the filter information is created based on the bandwidth of the pass band narrowing occurring in the optical fiber transmission line 30, or the like. In this case, the filter information is created based on the number of ROADMs provided between the transmitter node 10 and the optical transmission device 20 and the filter characteristics of the WSS implemented in each ROADM.

The filter 52 operates as a lowpass filter (LPF) or a bandpass filter (BPF). In this case, the filter information may designate a cutoff frequency. In the example illustrated in FIG. 9, the amplitude component indicated by hatching is removed or reduced by the filter 52. Hence, the spectrum of the reference signal is shaped. Specifically, a width of the spectrum of the reference signal is reduced.

The IFFT calculator 53 performs conversion from the frequency domain to the time domain by executing an inverse FFT calculation on the output signal of the filter 52. That is, the reference signal whose spectrum is shaped according to the characteristics of the optical fiber transmission line 30 is generated. Then, the reference signal is guided to the correlation calculator 43d.

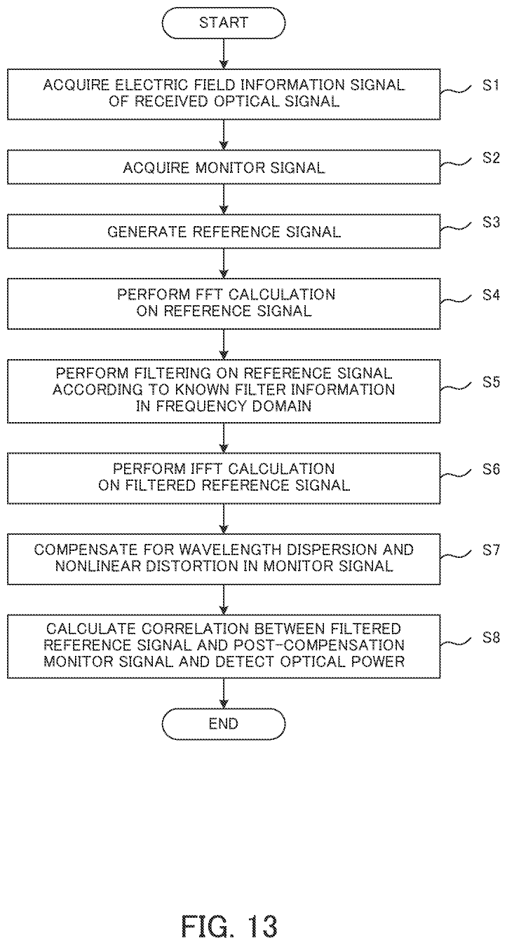

FIG. 13 is a flowchart illustrating an example of a process of the optical transmission line monitoring device according to the first embodiment of the present invention. Note that the optical transmission device 20 receives the optical signal transmitted from the transmitter node 10 via the optical fiber transmission line 30.

In S1, the optical transmission device 20 generates the electric field information signal of the received optical signal. At this time, the digital signal processor 22 recovers the transmission data from the electric field information signal. In S2, the optical transmission line monitoring device 40B acquires the monitor signal. The monitor signal can be acquired, for example, by the method illustrated in FIG. 8 or 10. In S3, the transmission waveform reconfiguration unit 41 reconfigures the transmission waveform from the recovered transmission data to generate the reference signal.

In S4, the spectrum shaper 45 performs an FFT calculation on the reference signal. By this FFT calculation, the reference signal is converted from the time domain to the frequency domain. In S5, the spectrum shaper 45 filters the reference signal according to the filter information prepared in advance in the frequency domain. It is assumed that the filter information is created in advance based on the configuration of the optical fiber transmission line (for example, the number of ROADMs, filter characteristics of the WSS in each ROADM, and the like). In S6, the spectrum shaper 45 performs an IFFT calculation on the filtered reference signal. By this IFFT calculation, the reference signal is converted from the frequency domain to the time domain. Thus, in S4 to S6, the spectrum of the reference signal is shaped according to the filter information.

In S7, the characteristics extractor 43 compensates for the chromatic dispersion and the nonlinear distortion in the monitor signal. At this time, the characteristics extractor 43 sequentially compensates for the chromatic dispersion CD1, the nonlinear distortion, and the chromatic dispersion CD2. In S8, the correlation calculator 43d calculates the correlation between the filtered reference signal and the post-compensation monitor signal. As described above, this correlation value indicates the optical power at a position corresponding to the combination of the chromatic dispersion CD1 and the chromatic dispersion CD2. Accordingly, the power profile is generated by calculating the correlation value while changing the combination of the chromatic dispersion CD1 and the chromatic dispersion CD2.

### Second Embodiment

In the first embodiment, the filter information is prepared in advance from known information. On the other hand, in the second embodiment, the filter information is generated based on the electric field information of the optical signal received by the optical transmission device 20.

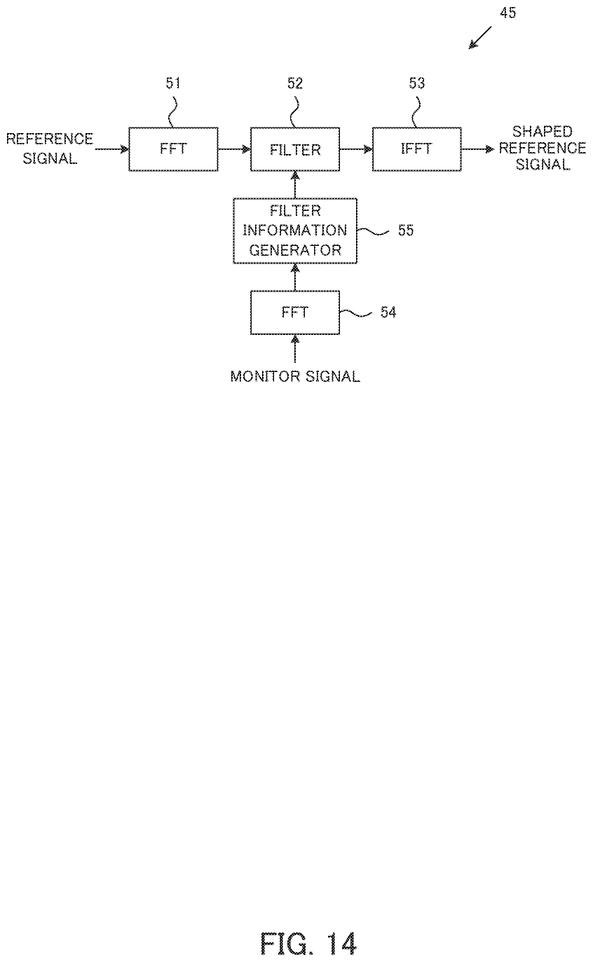

FIG. 14 illustrates an example of a spectrum shaper provided in an optical transmission line monitoring device according to the second embodiment of the present invention. In this example, the spectrum shaper 45 includes the FFT calculator 51, the filter 52, the IFFT calculator 53, an FFT calculator 54, and a filter information generator 55. Note that the FFT calculator 51, the filter 52, and the IFFT calculator 53 are substantially the same in the first embodiment illustrated in FIG. 12 and the second embodiment illustrated in FIG. 14.

The FFT calculator 54 executes an FFT calculation on the monitor signal. By this calculation, the monitor signal is converted from the time domain to the frequency domain. That is, the spectrum of the monitor signal is obtained. Then, the filter information generator 55 generates filter information to be given to the filter 52 based on the spectrum of the monitor signal. Here, the monitor signal indicates the electric field information of the optical signal affected by the optical fiber transmission line 30. That is, the monitor signal indicates the electric field information of the optical signal affected by the pass band narrowing. Accordingly, the influence of the pass band narrowing can be detected based on the spectrum of the monitor signal. Then, the filter information generator 55 generates filter information indicating the influence of the pass band narrowing on the optical signal and gives the filter information to the filter 52. Note that the filter information may designate a cutoff frequency.

The filter 52 filters the reference signal according to the filter information generated by the filter information generator 55 in the frequency domain. Here, the filter information indicates the influence of the pass band narrowing on the optical signal. Accordingly, by performing filtering according to the filter information, the reference signal affected by the pass band narrowing is obtained.

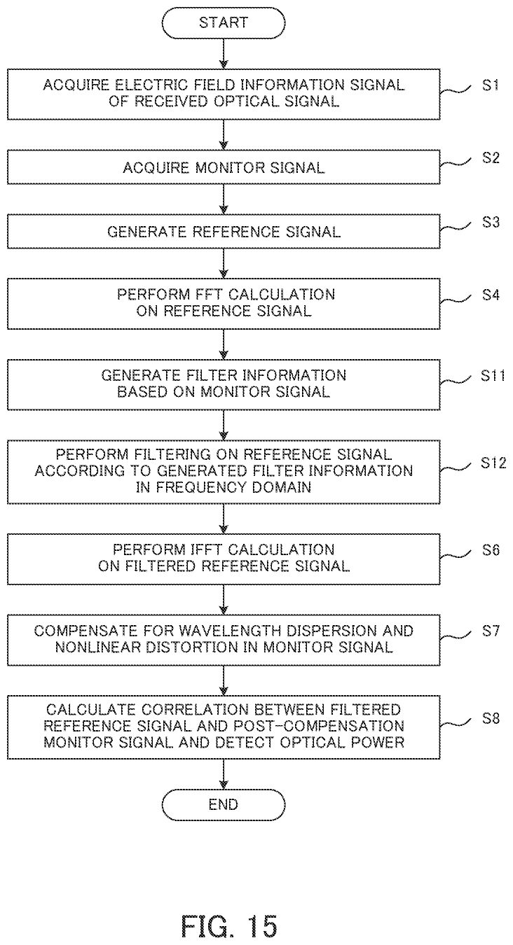

FIG. 15 is a flowchart illustrating an example of a process of the optical transmission line monitoring device according to the second embodiment of the present invention. Note that S1 to S4 and S6 to S8 are substantially the same in the first embodiment illustrated in FIG. 13 and the second embodiment illustrated in FIG. 15. That is, in the second embodiment, the process of S11 to S12 is executed instead of S5 illustrated in FIG. 13.

In S11, the FFT calculator 54 executes an FFT calculation on the monitor signal. Then, the filter information generator 55 generates filter information based on the monitor signal converted into the frequency domain. In S12, the filter 52 shapes the spectrum of the reference signal according to the filter information generated by the filter information generator 55. Thereafter, similarly to the first embodiment, the optical power is detected by calculating the correlation between the filtered reference signal and the post-compensation monitor signal.

As described above, in the second embodiment, the influence of the pass band narrowing on the optical signal is detected using the monitor signal. Then, the reference signal is filtered based on the influence of the pass band narrowing. Therefore, according to the second embodiment, it is possible to bring the spectrum of the reference signal to be similar to the spectrum of the monitor signal as compared with the first embodiment.

### Third Embodiment

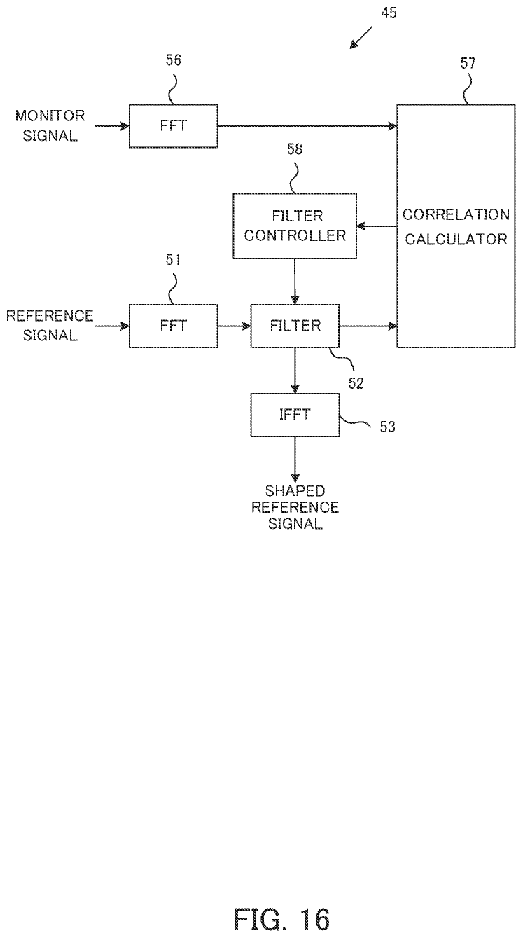

FIG. 16 illustrates an example of a spectrum shaper provided in an optical transmission line monitoring device according to the third embodiment of the present invention. In this example, the spectrum shaper 45 includes the FFT calculator 51, the filter 52, the IFFT calculator 53, an FFT calculator 56, a correlation calculator 57, and a filter controller 58. Note that the FFT calculator 51, the filter 52, and the IFFT calculator 53 are substantially the same in the first embodiment illustrated in FIG. 12 and the third embodiment illustrated in FIG. 16. That is, the FFT calculator 51 generates a reference signal in the frequency domain by executing an FFT calculation on the reference signal. The filter 52 filters the reference signal in the frequency domain.

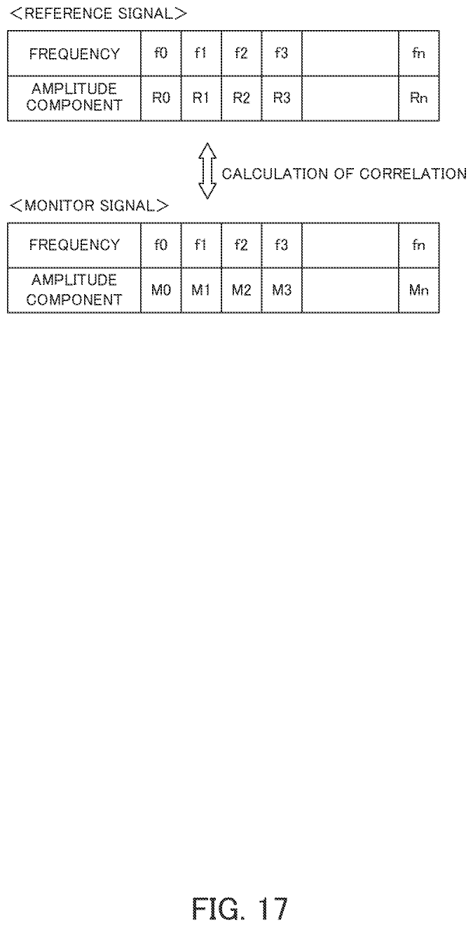

The FFT calculator 56 executes an FFT calculation on the monitor signal. The correlation calculator 57 calculates a correlation between the output signal of the FFT calculator 56 and the output signal of the filter 52. That is, the correlation calculator 57 calculates the correlation between the monitor signal and the filtered reference signal in the frequency domain. Here, in the frequency domain, for example, as illustrated in FIG. 17, the monitor signal and the reference signal are indicated by an array that stores a value of amplitude component (or signal intensity) for each frequency. R0 to Rn indicate amplitude components of the filtered reference signal at frequencies f0 to fn, and M0 to Mn indicate amplitude components of the monitor signal at frequencies f0 to fn. In this case, the correlation calculator 57 calculates the correlation between R0 to Rn and M0 to Mn.

The filter controller 58 controls the filter 52 based on the correlation between the monitor signal and the filtered reference signal. At this time, the filter controller 58 updates the pass band of the filter 52 so that the correlation between the monitor signal and the filtered reference signal increases.

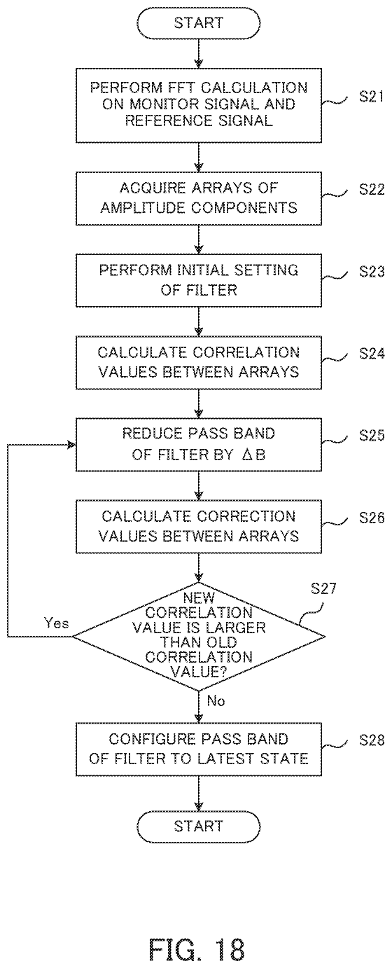

FIG. 18 is a flowchart illustrating an example of a method of configuring a filter in the third embodiment. Note that the pass band of the filter for shaping the spectrum of the reference signal is configured by the procedure of this flowchart.

In S21 to S22, the FFT calculator 51 executes the FFT calculation on the reference signal, and the FFT calculator 56 executes the FFT calculation on the monitor signal. As a result, arrays of amplitude components are generated for the reference signal and the monitor signal. That is, an array R0 to Rn and an array M0 to Mn illustrated in FIG. 17 are generated.

In S23, the filter controller 58 performs initial setting of the pass band of the filter 52. In the initial setting, for example, a pass band obtained by adding a margin to the pass band corresponding to the filter information of the first embodiment is used. The margin is not particularly limited, but is, for example, 2 GHz.

In S24, the correlation calculator 57 calculates a correlation value between the array R0 to Rn and the array M0 to Mn. At this time, the array R0 to Rn indicates amplitude components of the reference signal filtered by the filter 52 in the initial setting state. The array M0 to Mn indicates amplitude components of the monitor signal.

In S25, the filter controller 58 reduces the pass band of the filter 52 by ΔB. At this time, one end of the pass band of the filter 52 is reduced. Then, the reference signal is filtered by the filter 52 whose pass band has been updated. As a result, the values of the array R0 to Rn are updated. Note that ΔB is not particularly limited, but is, for example, 0.1 GHz.

In S26, the correlation calculator 57 calculates a correlation value between the array R0 to Rn and the array M0 to Mn. At this time, the array R0 to Rn indicates amplitude components of the reference signal filtered by the filter 52 whose pass band has been reduced in S25. The array M0 to Mn indicates amplitude components of the monitor signal.

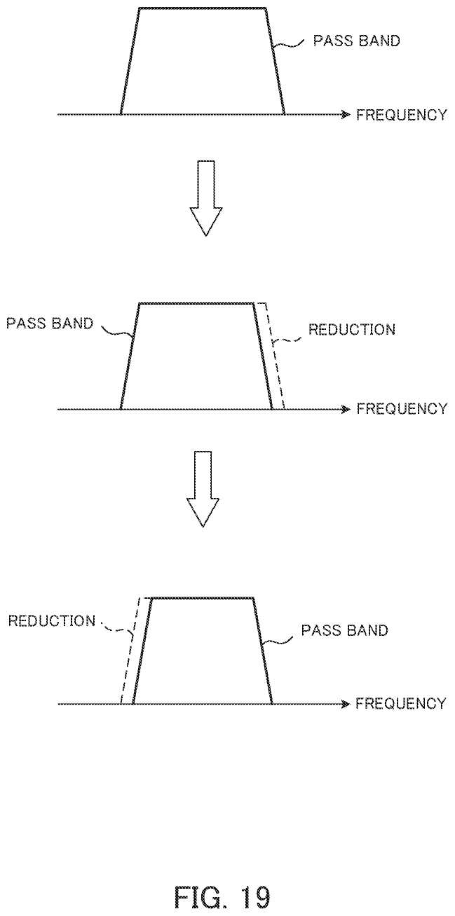

In S27, the filter controller 58 compares the newly calculated correlation value with the correlation value calculated immediately before. When the newly calculated correlation value is larger than the correlation value calculated immediately before, the process of the spectrum shaper 45 returns to S25. That is, the process of S25 to S27 is repeatedly executed until the newly calculated correlation value becomes equal to or less than the correlation value calculated immediately before. In this loop process, the pass band of the filter 52 is gradually reduced. At this time, as illustrated in FIG. 19, the pass band of the filter 52 is preferably reduced alternately at the end on the high frequency side and the end on the low frequency side. Then, when the newly calculated correlation value becomes equal to or less than the correlation value calculated immediately before, the process of the spectrum shaper 45 proceeds to S28. That is, when the correlation value reaches the maximum value, the process of the spectrum shaper 45 proceeds to S28.

In S28, the filter controller 58 configures the pass band obtained by the latest loop process in the filter 52. As a result, the filter 52 is configured to a state equivalent to the pass band narrowing occurring in the optical fiber transmission line 30.

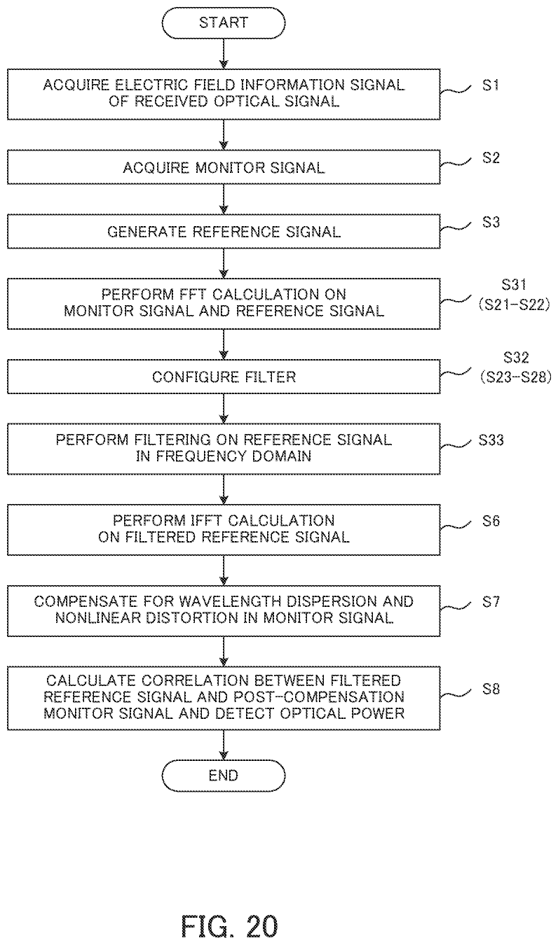

FIG. 20 is a flowchart illustrating an example of a process of the optical transmission line monitoring device according to the third embodiment of the present invention. Note that S1 to S3 and S6 to S8 are substantially the same in the first embodiment illustrated in FIG. 13 and the third embodiment illustrated in FIG. 20. That is, in the third embodiment, the processing of S31 to S33 is executed instead of S4 to S5 illustrated in FIG. 13.

In S31, the FFT calculator 51 executes the FFT calculation on the reference signal, and the FFT calculator 56 executes the FFT calculation on the monitor signal. As a result, arrays of amplitude components are generated for the reference signal and the monitor signal. Note that S31 corresponds to S21 to S22 illustrated in FIG. 18.

In S32, the spectrum shaper 45 configures the pass band of the filter 52 that filters the reference signal. Note that S32 corresponds to S23 to S28 illustrated in FIG. 18. In S33, the filter 52 filters the reference signal using the pass band configured in S32. Thereafter, similarly to the first embodiment, the optical power is detected by calculating the correlation between the filtered reference signal and the post-compensation monitor signal.

As described above, in the third embodiment, the pass band of the filter 52 is alternately reduced at the end on the high frequency side and the end on the low frequency side while calculating the correlation between the monitor signal and the filtered reference signal. Accordingly, even in an optical fiber transmission line in which pass band narrowing asymmetric with respect to the center wavelength of a target channel occurs, a filter corresponding to such pass band narrowing can be configured, and thus, the measurement accuracy of the optical power by the optical transmission line monitoring device 40B becomes high.

### Fourth Embodiment

In the first to third embodiments, the optical transmission line monitoring device generates the power profile of the optical fiber transmission line 30. An optical transmission device according to the fourth embodiment estimates the type of an optical fiber provided in each span using the power profile of the optical fiber transmission line 30.

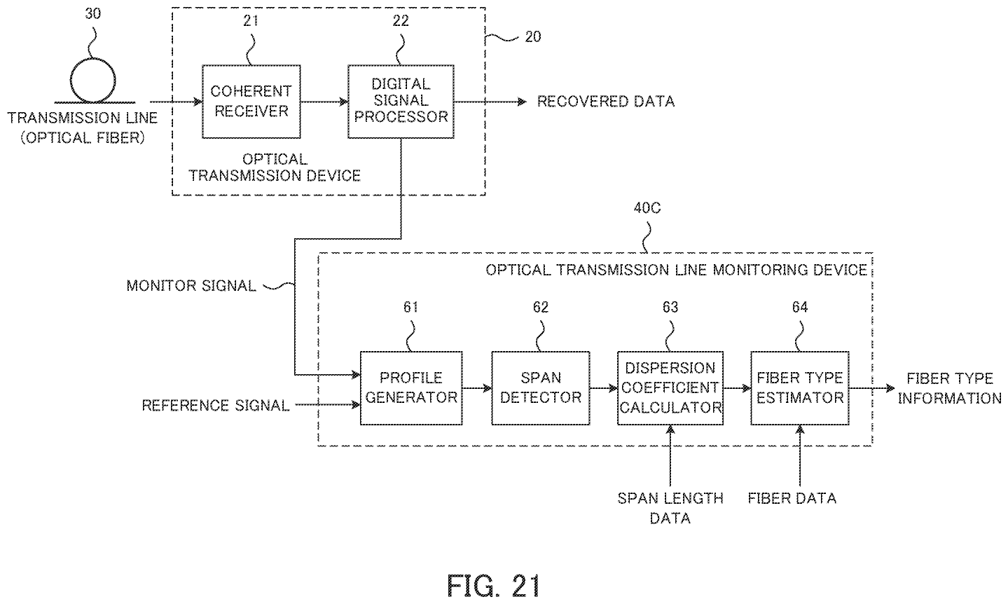

FIG. 21 illustrates an example of an optical transmission line monitoring device according to the fourth embodiment of the present invention. An optical transmission line monitoring device 40C according to the fourth embodiment includes a profile generator 61, a span detector 62, a dispersion coefficient calculator 63, and a fiber type estimator 64. Note that the profile generator 61 corresponds to the transmission data storage 44, the transmission waveform reconfiguration unit 41, the spectrum shaper 45, the monitor signal storage 42, and the characteristics extractor 43 illustrated in FIG. 8. Accordingly, the profile generator 61 can generate the power profile of the optical fiber transmission line 30 based on the electric field information of the optical signal received by the optical transmission device 20. The optical transmission line monitoring device 40C is achieved by, for example, a computer including a processor and a memory. Alternatively, the optical transmission line monitoring device 40C may be achieved by a signal processing circuit that processes a digital signal.

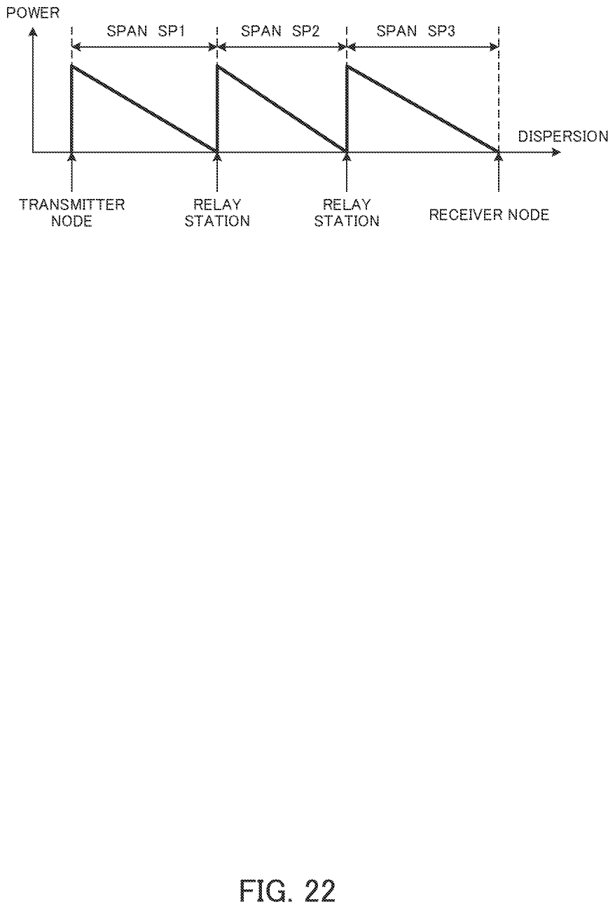

The span detector 62 detects one or a plurality of spans constituting the optical fiber transmission line 30 using the power profile generated by the profile generator 61. For example, a section between each peak and an adjacent peak appearing in the power profile is detected as a span. In the example illustrated in FIG. 22, three spans (SP1 to SP3) are detected between the transmitter node and the receiver node.

The dispersion coefficient calculator 63 estimates the dispersion amount of each span detected by the span detector 62. The dispersion amount of the span corresponds to the difference between a dispersion value at which a peak appears and a dispersion value at which an adjacent peak appears in the power profile. Then, the dispersion coefficient calculator 63 calculates a dispersion coefficient of the optical fiber transmission line 30 for each span. At this time, the dispersion coefficient is calculated, for example, by dividing the dispersion amount estimated based on the power profile by the span length. The span length of each span is known and prepared in advance as span length data.

The fiber type estimator 64 estimates the type of the optical fiber constituting the optical fiber transmission line 30 based on the dispersion coefficient calculated by the dispersion coefficient calculator 63 for each span detected by the span detector 62.

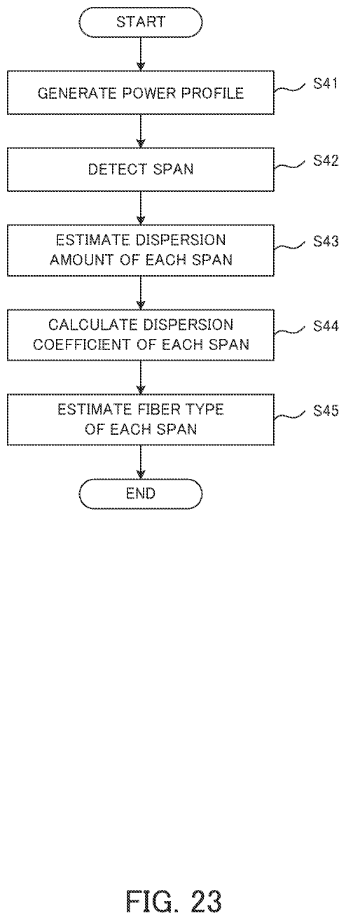

FIG. 23 is a flowchart illustrating an example of a process of the optical transmission line monitoring device according to the fourth embodiment. Note that it is assumed that the span length of each span constituting the optical fiber transmission line 30 is known. In addition, the dispersion coefficient of a typical optical fiber is also known.

In S41, the profile generator 61 generates the power profile based on the monitor signal and the reference signal as described above. In S42, the span detector 62 detects one or a plurality of spans constituting the optical fiber transmission line using the power profile generated by the profile generator 61. In S43, the dispersion coefficient calculator 63 estimates the dispersion amount of the optical fiber transmission line 30 based on the power profile for each span detected by the span detector 62. Here, in the power profile, the power of the optical signal is plotted with respect to the dispersion amount of the optical fiber transmission line 30. Thus, the dispersion amount of each span can be estimated by specifying the dispersion value at which the peak of the optical power appears in the power profile.

In S44, the dispersion coefficient calculator 63 calculates a dispersion coefficient of the optical fiber transmission line 30 for each span. The dispersion coefficient is calculated by dividing the dispersion amount estimated based on the power profile by the span length. In S45, the fiber type estimator 64 estimates the fiber type based on the dispersion coefficient for each span.

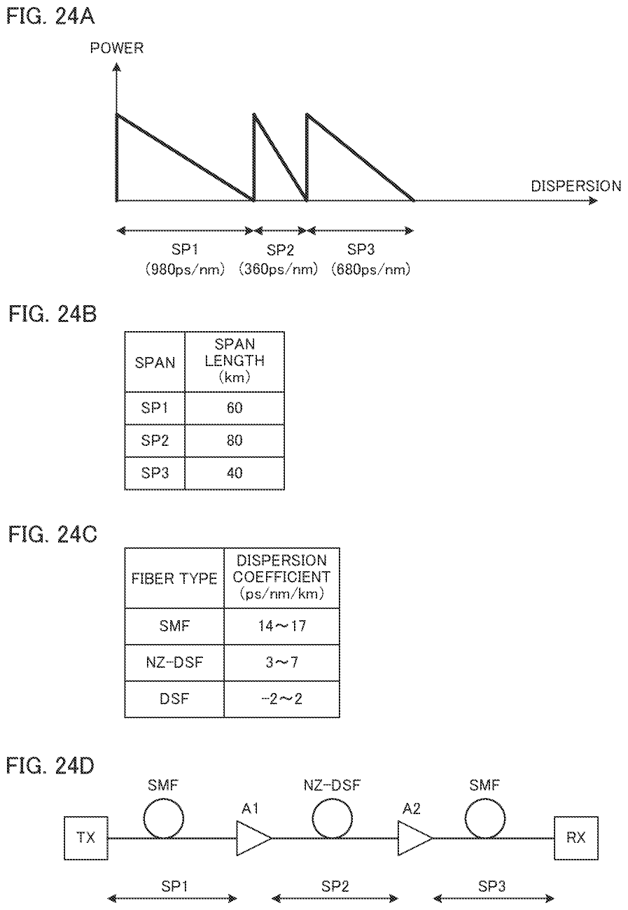

For example, it is assumed that the power profile illustrated in FIG. 24A is generated by the profile generator 61. In this case, three spans SP1 to SP3 are detected by the span detector 62. Thus, the optical transmission line monitoring device 40C estimates the type of the optical fiber constituting each of the spans SP1 to SP3.

The dispersion coefficient calculator 63 calculates the dispersion amount of each of the spans SP1 to SP3. In this example, the dispersion amount of each of the spans SP1 to SP3 is as illustrated in FIG. 24A. Subsequently, the dispersion coefficient calculator 63 calculates the dispersion coefficient of each of the spans SP1 to SP3. Here, it is assumed that the length of each of the spans SP1 to SP3 is known, and the span length data illustrated in FIG. 24B is given to the dispersion coefficient calculator 63. Then, the dispersion coefficient calculator 63 calculates the dispersion coefficient by dividing the dispersion amount by the span length. As a result, the following results are obtained.
Span SP1: 16.3 ps/nm/km
Span SP2: 4.5 ps/nm/km
Span SP3: 17 ps/nm/km

The fiber type estimator 64 estimates the type of the optical fiber constituting each of the spans SP1 to SP3 based on the dispersion coefficient calculated by the dispersion coefficient calculator 63. Here, the dispersion coefficients of various optical fibers are known. For example, as illustrated in FIG. 24C, fiber data indicating the dispersion coefficients of various optical fibers is created. Then, the fiber type estimator 64 estimates the type of the optical fiber constituting each of the spans SP1 to SP3 with reference to the fiber data.

FIG. 24D illustrates an estimation result by the fiber type estimator 64. That is, since the dispersion coefficient calculated for the span SP1 between a transmitter node TX and a relay station A1 is 16.3 ps/nm/km, the optical fiber constituting the span SP1 is estimated to be a single mode optical fiber (SMF). Since the dispersion coefficient calculated for the span SP2 between the relay station A1 and a relay station A2 is 4.5 ps/nm/km, the optical fiber constituting the span SP2 is estimated to be a non-zero dispersion-shifted single mode optical fiber (NZ-DSF). Since the dispersion coefficient calculated for the span SP3 between the relay station A2 and a receiver node RX is 17 ps/nm/km, the optical fiber constituting the span SP3 is estimated to be a SMF.

### Effects of Embodiments of Present Invention

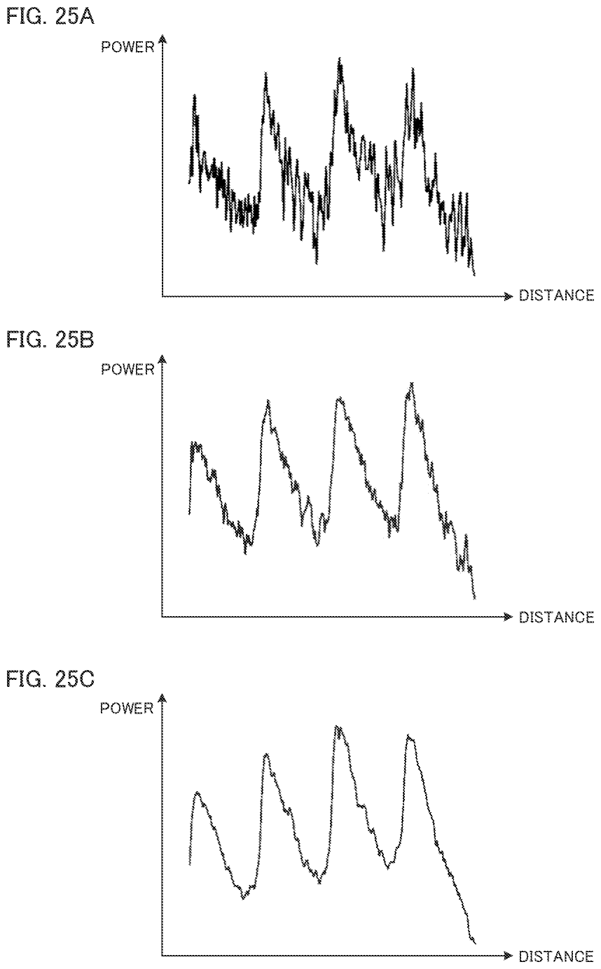

FIGS. 25A to 25C illustrate an example of a power profile of an optical fiber transmission line. In this example, three relay nodes are provided between the transmitter node and the receiver node. It is assumed that a specified pass band narrowing occurs on the optical fiber transmission line.

FIGS. 25A and 25B illustrate power profiles in a case where the spectrum shaping of the reference signal is not performed. When the spectrum shaping of the reference signal is not performed, a large noise component is generated in the power profile as illustrated in FIG. 25A. Here, the noise component is suppressed by acquiring the electric field information of the received optical signal at a plurality of different timings to generate a plurality of power profiles and averaging the power profiles. For example, FIG. 25B illustrates an average power profile when the number of times of averaging is ten.

The optical transmission line monitoring device 40B according to the embodiment of the present invention shapes the spectrum of the reference signal in consideration of pass band narrowing occurring in the optical fiber transmission line. As a result, as illustrated in FIG. 25C, the power profile in which the noise component is suppressed can be generated.

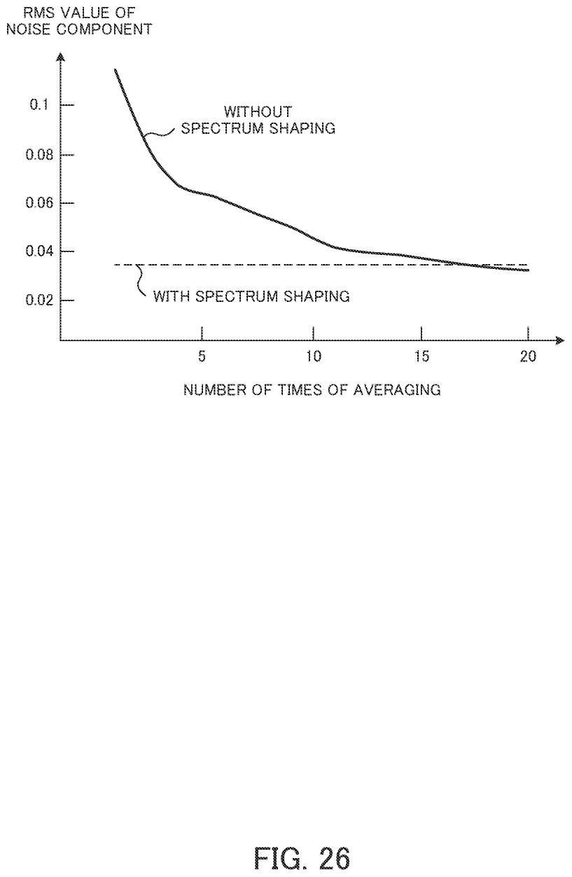

FIG. 26 illustrates RMS values of the noise component of a power profile. The RMS value of the noise component indicates a root mean square of the difference between a reference profile and the power profile generated by the optical transmission line monitoring device. Note that the reference profile corresponds to the power profile obtained when it is assumed that there is no pass band narrowing in the optical fiber transmission line.

The RMS value obtained according to the embodiment of the present invention is about 0.035. On the other hand, in the configuration in which the spectrum shaping of the reference signal is not performed (for example, the configuration illustrated in FIG. 1), the RMS value exceeds 0.1. As the number of times of averaging increases, the RMS value decreases. When averaging is performed 15 to 20 times, a noise suppression effect equivalent to that of the embodiment of the present invention can be obtained in the configuration in which the spectrum shaping of the reference signal is not performed. However, in the configuration in which the spectrum shaping of the reference signal is not performed, a calculation amount and a calculation time for obtaining an accurate power profile are increased. In other words, according to the embodiment of the present invention, an accurate power profile can be obtained with a small calculation amount and calculation time.

Comprehensive Configuration

In the examples illustrated in FIGS. 8 to 26, the optical transmission line monitoring device compensates for distortion caused by pass band narrowing (PBN) and creates the power profile of the optical fiber transmission line. However, the pass band narrowing is one of factors that cause distortion. That is, the distortion can occur due to various factors. Accordingly, the optical transmission line monitoring device preferably creates the power profile of the optical fiber transmission line in consideration of these factors.

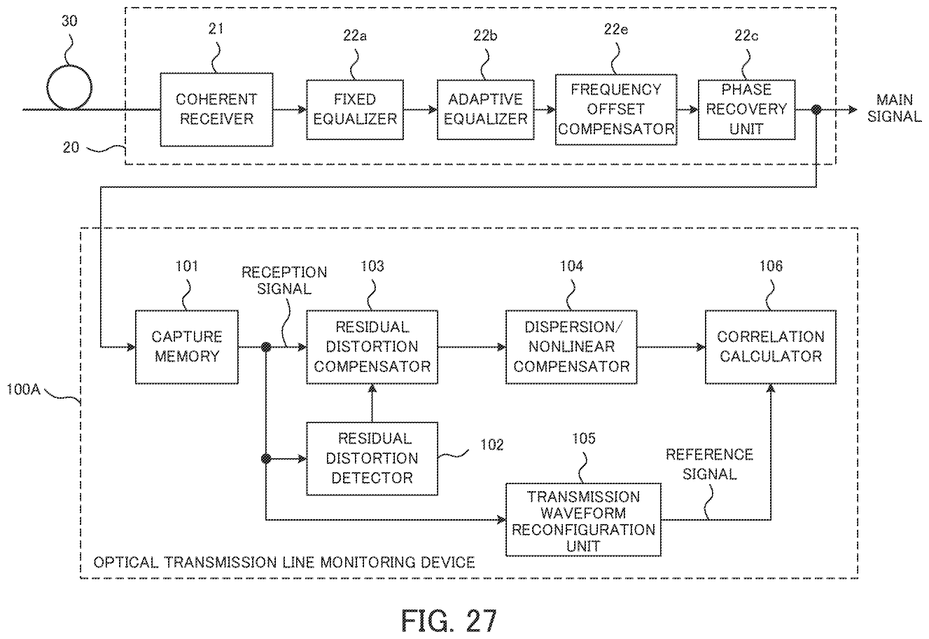

FIG. 27 illustrates an example of an optical transmission line monitoring device that compensates for arbitrary distortion and creates a power profile. Similarly to the optical transmission line monitoring device 40 illustrated in FIG. 1, an optical transmission line monitoring device 100A illustrated in FIG. 27 creates the power profile of the optical fiber transmission line between the transmitter node 10 and the optical transmission device 20 using the electric field information signal generated by the optical transmission device 20. Note that the optical transmission device 20 includes the coherent receiver 21, the fixed equalizer 22a, the adaptive equalizer 22b, a frequency offset compensator 22e, and the phase recovery unit 22c. The coherent receiver 21, the fixed equalizer 22a, the adaptive equalizer 22b, and the phase recovery unit 22c are as described with reference to FIGS. 1 and 2. The frequency offset compensator 22e compensates for the frequency offset between the transmitter node 10 and the optical transmission device 20.

Note that, in the configurations illustrated in FIGS. 2, 8, 10, and 11, the frequency offset compensator 22e is omitted. In addition, the decision unit 22d illustrated in FIGS. 2, 8, 10, and 11 is provided in a transmission waveform reconfiguration unit 105 to be described below.

The optical transmission line monitoring device 100A includes a capture memory 101, a residual distortion detector 102, a residual distortion compensator 103, a dispersion/nonlinear compensator 104, the transmission waveform reconfiguration unit 105, and a correlation calculator 106. Note that the optical transmission line monitoring device 100A may have other functions not illustrated in FIG. 27. The optical transmission line monitoring device 100A is achieved by, for example, a computer including a processor and a memory. Alternatively, the optical transmission line monitoring device 100A may be achieved by a signal processing circuit that processes a digital signal.

The capture memory 101 temporarily stores the electric field information signal generated by the optical transmission device 20. The electric field information signal indicates the electric field of the optical signal received by the optical transmission device 20 via the optical fiber transmission line 30. Accordingly, in the following description, the electric field information signal generated by the optical transmission device 20 and stored in the capture memory 101 may be referred to as a “reception signal”. This reception signal corresponds to the monitor signal illustrated in FIG. 8. In addition, the capture memory 101 corresponds to the monitor signal storage 42 illustrated in FIG. 8.

Note that, in the example illustrated in FIG. 27, the output signal of the phase recovery unit 22c is stored in the capture memory 101, but the embodiment of the present invention is not limited to this configuration. In addition, the electric field information signal generated within a specified monitoring time is stored in the capture memory 101. Specifically, a specified number of electric field information signals necessary for creating the power profile is stored in the capture memory 101.

The residual distortion detector 102 detects distortion added to the received optical signal based on the reception signal. However, the chromatic dispersion and the nonlinear distortion of the optical fiber transmission line 30 are compensated for by the dispersion/nonlinear compensator 104 to be described below. Accordingly, the residual distortion detector 102 detects a distortion component other than the nonlinear distortion. In the following description, a distortion component other than the nonlinear distortion may be referred to as a “residual distortion component”. Here, the residual distortion detector 102 does not need to detect all residual distortion components. That is, the residual distortion detector 102 may only detect one or a plurality of distortion components among various distortion components. Then, the residual distortion detector 102 calculates a residual distortion compensation amount for compensating for the detected residual distortion.

The residual distortion compensator 103 compensates for residual distortion of the reception signal based on the detection result by the residual distortion detector 102. That is, the residual distortion compensator 103 compensates for the residual distortion of the reception signal based on the residual distortion compensation amount calculated by the residual distortion detector 102.

The dispersion/nonlinear compensator 104 includes the first dispersion compensator 43a, the nonlinear compensator 43b, and the second dispersion compensator 43c illustrated in FIG. 1 and the like. The first dispersion compensator 43a compensates for a part of chromatic dispersion (hereinafter, first chromatic dispersion) of the chromatic dispersion of the optical fiber transmission line in the reception signal whose residual distortion is compensated for by the residual distortion compensator 103. The nonlinear compensator 43b compensates for nonlinear distortion of the optical fiber transmission line 30 in the output signal of the first dispersion compensator 43a. The second dispersion compensator 43c compensates for the remaining chromatic dispersion (hereinafter, second chromatic dispersion) of the chromatic dispersion of the optical fiber transmission line 30 in the output signal of the nonlinear compensator 43b.

The transmission waveform reconfiguration unit 105 corresponds to the transmission waveform reconfiguration unit 41 illustrated in FIG. 8. However, the transmission waveform reconfiguration unit 105 illustrated in FIG. 27 includes the decision unit 22d illustrated in FIG. 8. That is, the transmission waveform reconfiguration unit 105 recovers a transmission symbol based on the phase and amplitude of the reception signal. Then, the transmission waveform reconfiguration unit 105 generates the electric field information signal by mapping the transmission symbol on the constellation. Here, the mapping by the transmission waveform reconfiguration unit 105 is substantially the same as mapping performed at the transmitter node 10. Thus, the electric field information signal generated by the transmission waveform reconfiguration unit 105 is substantially the same as the electric field information signal for generating the optical signal in the transmitter node 10. That is, the output signal of the transmission waveform reconfiguration unit 105 indicates the electric field of the optical signal at the transmitter node 10. Note that, in the following description, the output signal (that is, the electric field information signal for generating the optical signal at the transmitter node 10) of the transmission waveform reconfiguration unit 105 may be referred to as a “reference signal”.

The correlation calculator 106 is substantially the same as the correlation calculator 43d illustrated in FIG. 1 or 8. That is, the correlation calculator 106 calculates a correlation between the output signal of the dispersion/nonlinear compensator 104 and the output signal (that is, the reference signal) of the transmission waveform reconfiguration unit 105. As described above, the reference signal indicates the electric field of the optical signal at the transmitter node 10.

The correlation calculator 106 measures the optical power based on the difference in a nonlinear distortion component between the reception signal and the reference signal. Therefore, in order to increase the measurement accuracy or the measurement sensitivity of the optical power, it is preferable that the residual distortion added to the reception signal and the residual distortion added to the reference signal are the same when the correlation calculator 106 calculates the correlation between the reception signal and the reference signal. Here, since the reference signal is reconfigured from the transmission symbol, the residual distortion is substantially zero. Thus, the residual distortion compensator 103 compensates for (or removes) the residual distortion in the reception signal. As a result, the residual distortions of the reception signal and the reference signal become substantially the same (alternatively, the residual distortions of the reception signal and the reference signal are both substantially zero). Accordingly, since the difference in the nonlinear distortion component between the reception signal and the reference signal can be accurately monitored, a high-quality power profile can be created.

The correlation value calculated by the correlation calculator 106 indicates the power of the optical signal at an arbitrary point on the optical fiber transmission line 30. Accordingly, as described with reference to FIGS. 3 to 6C, the power profile of the optical fiber transmission line can be obtained by changing the combination of the dispersion amount compensated for by the first dispersion compensator 43a and the dispersion amount compensated for by the second dispersion compensator 43c.

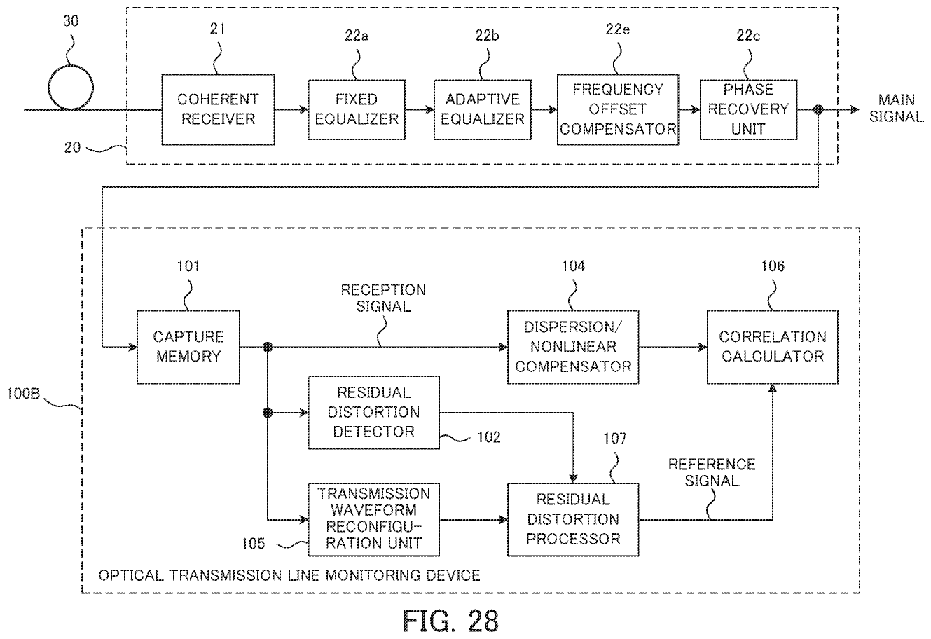

FIG. 28 illustrates another example of an optical transmission line monitoring device that compensates for arbitrary distortion and creates a power profile. In the configuration illustrated in FIG. 27, the optical transmission line monitoring device 100A compensates for the residual distortion of the reception signal. On the other hand, an optical transmission line monitoring device 100B illustrated in FIG. 28 corrects the output signal (that is, the reference signal indicating the transmission symbol generated by the transmitter node 10) of the transmission waveform reconfiguration unit 105 based on the residual distortion of the reception signal.

The optical transmission line monitoring device 100B includes the capture memory 101, the residual distortion detector 102, the dispersion/nonlinear compensator 104, the transmission waveform reconfiguration unit 105, the correlation calculator 106, and a residual distortion processor 107. Here, the capture memory 101, the residual distortion detector 102, the dispersion/nonlinear compensator 104, the transmission waveform reconfiguration unit 105, and the correlation calculator 106 are substantially the same in the optical transmission line monitoring device 100A illustrated in FIG. 27 and the optical transmission line monitoring device 100B illustrated in FIG. 28. The optical transmission line monitoring device 100B is achieved by, for example, a computer including a processor and a memory. Alternatively, the optical transmission line monitoring device 100B may be achieved by a signal processing circuit that processes a digital signal.

The residual distortion processor 107 processes the output signal of the transmission waveform reconfiguration unit 105 based on the residual distortion detected by the residual distortion detector 102. Here, as described above, it is preferable that the residual distortion added to the reception signal and the residual distortion added to the reference signal are the same when the correlation calculator 106 calculates the correlation between the reception signal and the reference signal. Thus, the residual distortion processor 107 corrects the output signal of the transmission waveform reconfiguration unit 105 so that the residual distortion added to the reception signal and the residual distortion added to the reference signal are the same. Specifically, since the residual distortion is added to the reception signal (or the output signal of the dispersion/nonlinear compensator 104), the residual distortion processor 107 adds the residual distortion detected by the residual distortion detector 102 to, for example, the output signal of the transmission waveform reconfiguration unit 105. As a result, the residual distortions of the reception signal and the reference signal are substantially the same, and the difference in the nonlinear distortion component between the reception signal and the reference signal can be accurately monitored.

Note that the optical transmission line monitoring device 40B illustrated in FIG. 8 is an example of the optical transmission line monitoring device 100B illustrated in FIG. 28. Specifically, in the optical transmission line monitoring device 40B, the residual distortion is a spectrum distortion caused by pass band narrowing. In addition, the spectrum shaper 45 is an example of the residual distortion processor 107, and shapes the spectrum of the reference signal to add residual distortion to the reference signal.

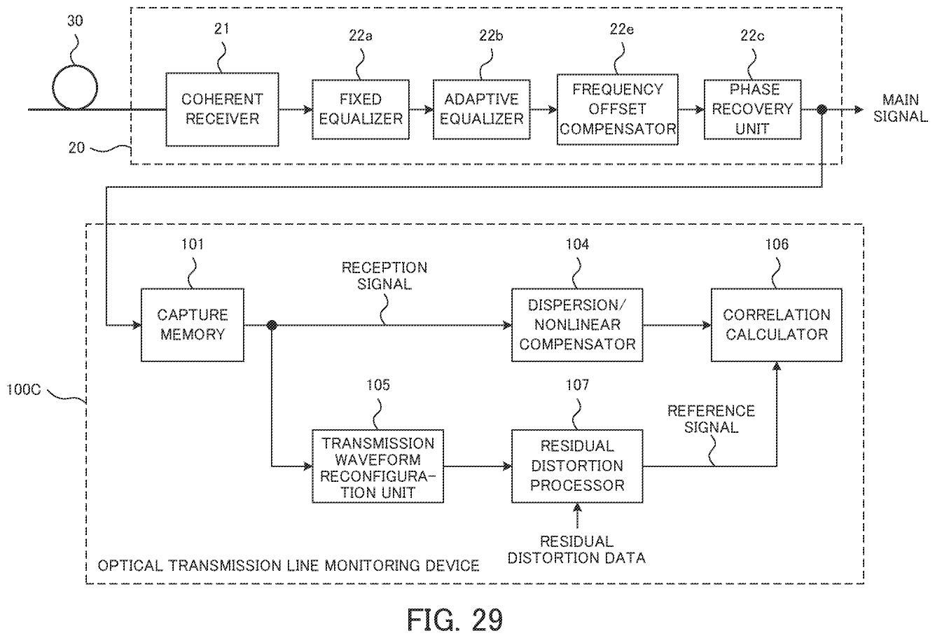

In the configuration for correcting the reference signal, when the residual distortion is known by measurement, simulation, or the like, the optical transmission line monitoring device does not need to include the residual distortion detector 102. In this case, as illustrated in FIG. 29, in an optical transmission line monitoring device 100C, known residual distortion data is given to the residual distortion processor 107. For example, the pass band narrowing illustrated in FIG. 7A can be calculated based on the performance of the ROADM implemented in each node, the number of ROADMs provided between the transmitter node 10 and the optical transmission device 20, and the like.

As described above, the optical transmission line monitoring device 100A illustrated in FIG. 27 has a function of compensating for the residual distortion (that is, another distortion different from the nonlinear distortion) of the reception signal. The optical transmission line monitoring devices 100B and 100C illustrated in FIGS. 28 and 29 have a function of adding residual distortion to the reference signal. Accordingly, measurement accuracy or measurement sensitivity of the optical power is increased, and a high-quality power profile can be created.

As the residual distortion, in addition to the above-described pass band narrowing, I/Q distortion, skew between I/Q, skew between polarized waves, higher-order chromatic dispersion, polarization mode dispersion, crosstalk between polarized waves, sampling phase shift, and the like are conceivable. In the following example, a configuration for compensating for I/Q distortion will be described.

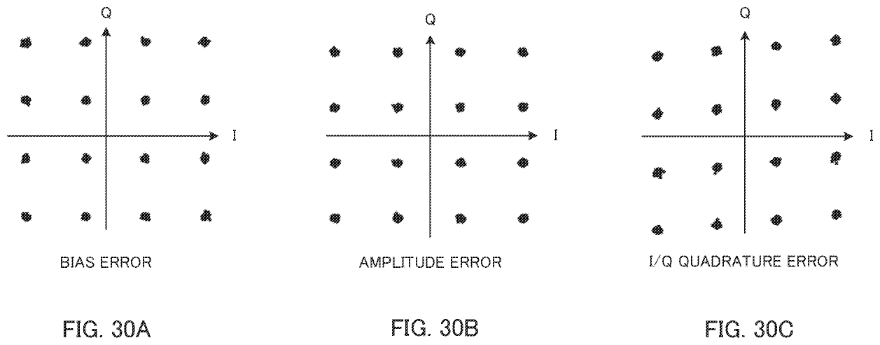

FIGS. 30A to 30C illustrate an example of I/Q distortion. In this example, 16 quadrature amplitude modulation (QAM) optical signal is transmitted between the transmitter node 10 and the optical transmission device 20. In 16 QAM, each symbol transmits 4 bits using 16 signal points. Each signal point is arranged on the constellation indicating a phase and an amplitude. Ideally, the 16 signal points are arranged symmetrically with respect to the in-phase (I) axis and are also arranged symmetrically with respect to the quadrature (Q) axis. However, the arrangement of the signal points may deviate from the ideal position due to various factors. In the following description, the state in which the arrangement of the signal points is deviated from the ideal position on the constellation may be referred to as “I/Q distortion”.

FIG. 30A illustrates an example of I/Q distortion caused by a bias error. In this example, the position of each signal point is shifted in the upper right direction with respect to the ideal position. That is, the values of the I component and the Q component of each signal point are shifted to the positive side with respect to the ideal value. This I/Q distortion is mainly caused by an error of a bias voltage for controlling an optical modulator in the transmitter node 10.

FIG. 30B illustrates an example of I/Q distortion caused by an amplitude error. In this example, the amplitude of the I component is larger than the amplitude of the Q component. This I/Q distortion is caused by, for example, an error in the amplitude of a drive signal for controlling the optical modulator in the transmitter node 10.

FIG. 30C illustrates an example of I/Q distortion caused by an I/Q quadrature error. In this example, the shape of the area in which the 16 signal points are arranged is not a square but a parallelogram. This I/Q distortion is caused by, for example, an error of a π/2 phase shifter that adjusts a phase difference between an I component signal and a Q component signal in the optical modulator in the transmitter node 10.

The above-described I/Q distortion can be compensated for by digital signal processing at a receiver. However, when a high-speed signal is processed in real time, it is difficult to perform sufficient compensation processing. That is, in many cases, minimum compensation to the extent that symbols can be recovered may be performed. Therefore, even if the distortion of the main signal is compensated for by using the digital signal processor 22 implemented in the optical transmission device 20, it is difficult to completely compensate for the I/Q distortion. On the other hand, the optical transmission line monitoring device according to the embodiment of the present invention measures the optical power based on the difference in a nonlinear distortion component between the reception signal and the reference signal. Here, this difference is minute. Accordingly, if the I/Q distortion is not sufficiently compensated for, the I/Q distortion becomes noise in the measurement of the optical power. In addition, it is not necessary to perform real time processing in monitoring the optical transmission line. Therefore, the optical transmission line monitoring device has a function of compensating for the I/Q distortion with high accuracy.

### Fifth Embodiment

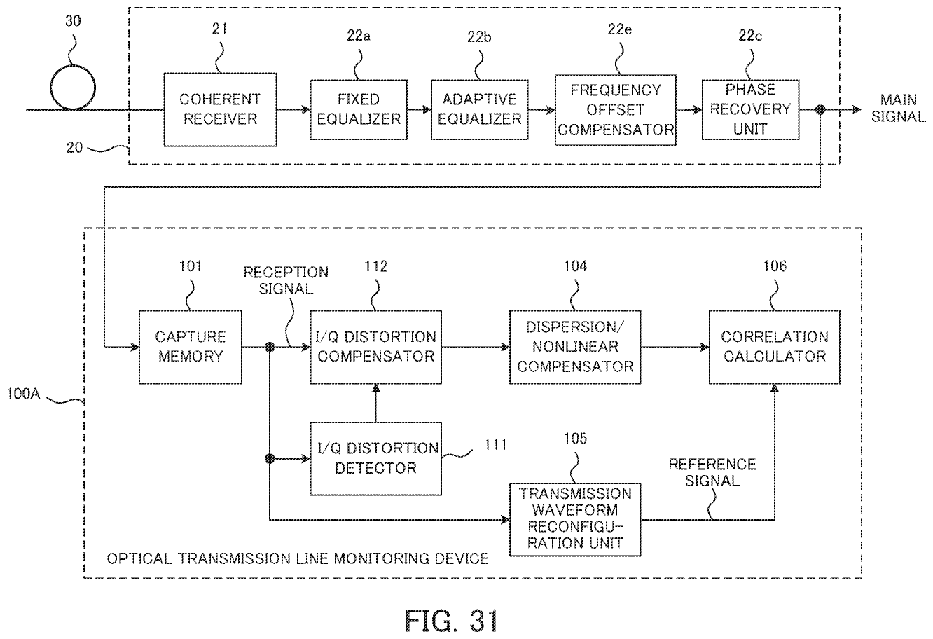

FIG. 31 illustrates an example of an optical transmission line monitoring device according to the fifth embodiment of the present invention. An optical transmission line monitoring device 100A according to the fifth embodiment has substantially the same configuration as that illustrated in FIG. 27. However, in the fifth embodiment, an I/Q distortion detector 111 and an I/Q distortion compensator 112 are implemented as the residual distortion detector 102 and the residual distortion compensator 103, respectively.

The I/Q distortion detector 111 detects the I/Q distortion caused by a bias error illustrated in FIG. 30A, the I/Q distortion caused by an amplitude error illustrated in FIG. 30B, and the I/Q distortion caused by an I/Q quadrature error illustrated in FIG. 30C. Then, the I/Q distortion compensator 112 compensates for the I/Q distortion detected by the I/Q distortion detector 111 in the reception signal. Here, since the optical transmission line monitoring device 100A does not need to measure the optical power in real time, it is possible to perform distortion compensation processing with high accuracy based on the electric field information signal stored in the capture memory 101.

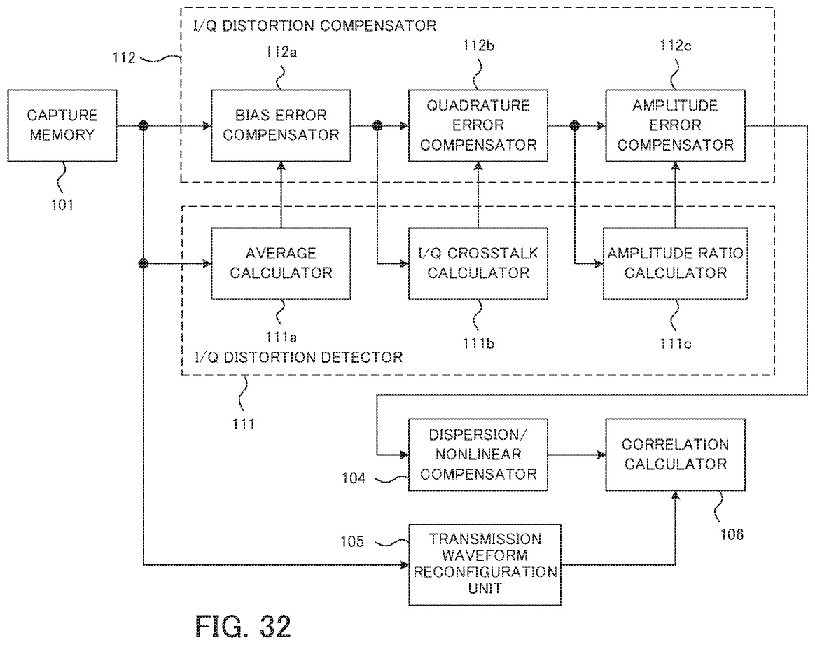

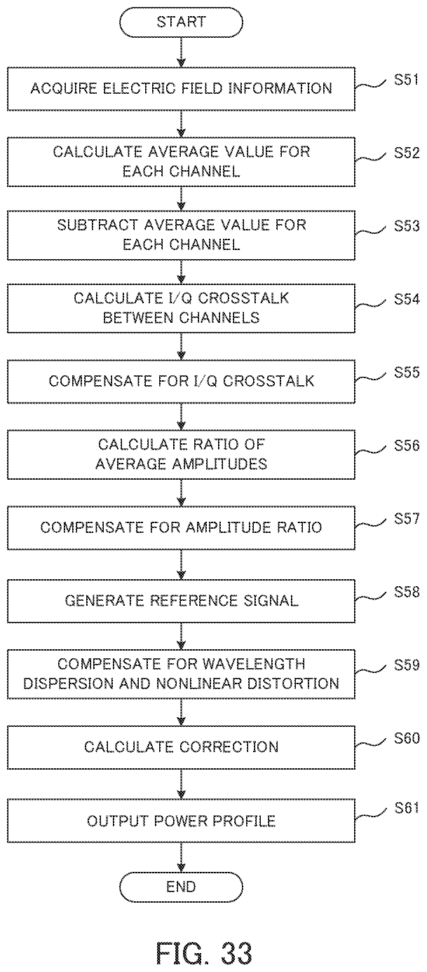

FIG. 32 illustrates a configuration example of the I/Q distortion detector 111 and the I/Q distortion compensator 112 of the fifth embodiment. In this example, the I/Q distortion detector 111 includes an average calculator 111a, a I/Q crosstalk calculator 111b, and an amplitude ratio calculator 111c. In addition, the I/Q distortion compensator 112 includes a bias error compensator 112a, a quadrature error compensator 112b, and an amplitude error compensator 112c. Hereinafter, operations of the I/Q distortion detector 111 and the I/Q distortion compensator 112 will be described with reference to a flowchart illustrated in FIG. 33.

FIG. 33 is a flowchart illustrating an example of a process of the optical transmission line monitoring device according to the fifth embodiment. Note that the optical transmission device 20 illustrated in FIG. 31 receives the optical signal transmitted from the transmitter node 10 illustrated in FIG. 1 via the optical fiber transmission line 30.

In S51, the optical transmission line monitoring device 100A acquires a specified number of electric field information signals. At this time, the optical transmission line monitoring device 100A gives a capture trigger signal to the capture memory 101. Then, the capture memory 101 stores the specified number of electric field information signals from the optical transmission device 20. That is, the electric field information signals for N reception symbols are stored in the capture memory 101.

In S52, the average calculator 111a calculates the average value of the electric fields for each of an I channel and a Q channel based on the electric field information signals stored in the capture memory 101. Here, assuming that there is no bias error in the transmitter node 10, the averages of the electric fields of the I channel and the Q channel are each zero. That is, the average value calculated in S52 indicates a deviation from the ideal electric field. Accordingly, in S53, the bias error compensator 112a subtracts the average value from the electric field information of each symbol. Specifically, in each symbol, the average value of the I channel is subtracted from the electric field information of the I channel, and the average value of the Q channel is subtracted from the electric field information of the Q channel. Hence, the bias error in the reception signal is compensated for.

In S54, the I/Q crosstalk calculator 111b calculates a I/Q crosstalk of the electric field between the I channel and the Q channel based on the output signal of the bias error compensator 112a. In this example, the I/Q crosstalk from the I channel to the Q channel is calculated. The I/Q crosstalk (sine) from the I channel to the Q channel is expressed by Formula (1). Note that, in Formula (1), “I” indicates the electric field of the I channel, and “Q” indicates the electric field of the Q channel.

$$sin θ = \frac{\sum I \times Q}{\sum {I}^{2}} \qquad ( 1 )$$

In S55, the quadrature error compensator 112b compensates for the I/Q crosstalk calculated in S54 for each symbol. The process of compensating for the I/Q crosstalk is expressed by Formula (2).

$$( \begin{matrix}I \\ Q\end{matrix} ) = ( \begin{matrix}1 & 0 \\ \frac{- sin θ}{cos θ} & \frac{1}{cos θ}\end{matrix} ) ( \begin{matrix}I \\ Q\end{matrix} ) \qquad ( 2 )$$

Hence, the I/Q quadrature error in the reception signal is compensated for.

In S56, the amplitude ratio calculator 111c calculates the ratio between the average amplitude of the I channel and the average amplitude of the Q channel based on the output signal of the quadrature error compensator 112b. In this example, a ratio c between the average amplitude of the I channel and the average amplitude of the Q channel is expressed by Formula (3).

$$c = \frac{\sum \vert I \vert}{\sum \vert Q \vert} \qquad ( 3 )$$

In S57, the amplitude error compensator 112c compensates for the amplitude ratio obtained in S56 for each symbol. In this example, the amplitude of the Q channel is corrected. In this case, the process of compensating for the amplitude ratio is expressed by Formula (4).

$$( \begin{matrix}I \\ Q\end{matrix} ) = ( \begin{matrix}1 & 0 \\ 0 & c\end{matrix} ) ( \begin{matrix}I \\ Q\end{matrix} ) \qquad ( 4 )$$

In S58, the transmission waveform reconfiguration unit 105 recovers the transmission symbol from the reception signal and reconfigures the transmission signal from the transmission symbol. This transmission signal is used as the reference signal in the optical transmission line monitoring device 100A. In S59, the dispersion/nonlinear compensator 104 compensates for the chromatic dispersion and the nonlinear distortion in the reception signal in which the I/Q distortion has been compensated for by the I/Q distortion compensator 112. In S60, the correlation calculator 106 calculates a correlation between the output signal (that is, the monitor signal) of the dispersion/nonlinear compensator 104 and the reference signal. Hence, the optical power of the optical fiber transmission line 30 is measured in a state where the I/Q distortion is compensated for. Then, in S61, the optical transmission line monitoring device 100A outputs the power profile.

Note that, in the examples illustrated in FIGS. 32 and 33, the bias error is first compensated for, the I/Q quadrature error is then compensated for, and the amplitude error is finally compensated for, but the embodiments of the present invention are not limited to this order. That is, the optical transmission line monitoring device 100A can compensate for the bias error, the I/Q quadrature error, and the amplitude error in any order. In addition, the optical transmission line monitoring device 100A may only compensate for one or more of the bias error, the I/Q quadrature error, and the amplitude error. Further, in the examples illustrated in FIGS. 32 and 33, the I/Q distortion is compensated for on the input side of the dispersion/nonlinear compensator 104, but the I/Q distortion may be compensated for on the output side of the dispersion/nonlinear compensator 104.

### Sixth Embodiment

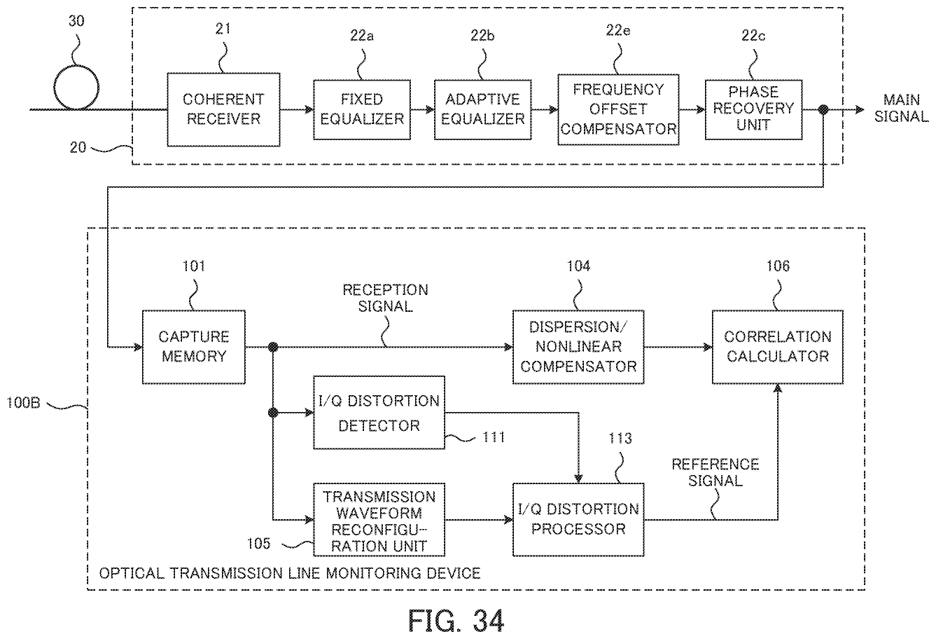

FIG. 34 illustrates an example of an optical transmission line monitoring device according to the sixth embodiment of the present invention. An optical transmission line monitoring device 100B according to the sixth embodiment has substantially the same configuration as that illustrated in FIG. 28. However, in the sixth embodiment, the I/Q distortion detector 111 and an I/Q distortion processor 113 are implemented as the residual distortion detector 102 and the residual distortion processor 107, respectively. Here, the I/Q distortion detector 111 is substantially the same in FIGS. 31 and 34. Then, the I/Q distortion processor 113 processes the transmission signal (that is, the reference signal) reconfigured by the transmission waveform reconfiguration unit 105 based on the I/Q distortion detected by the I/Q distortion detector 111.

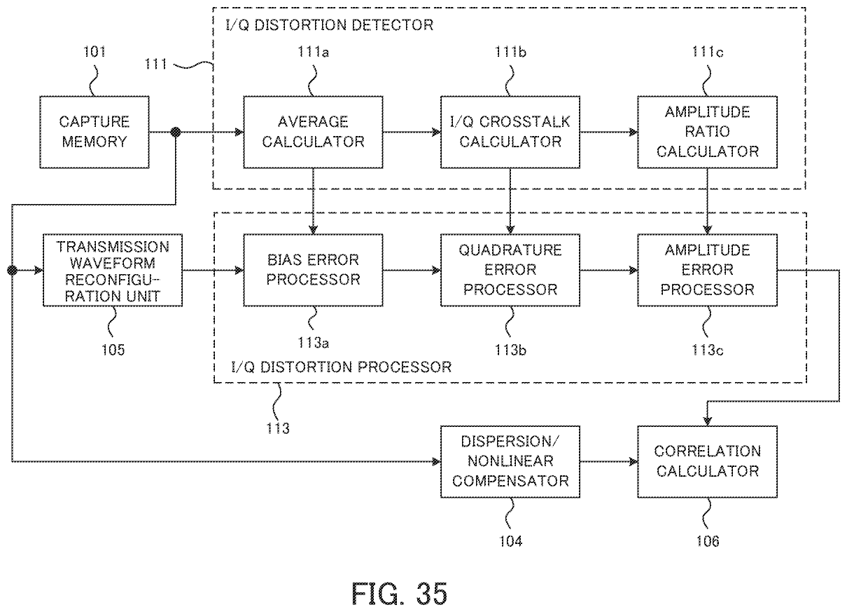

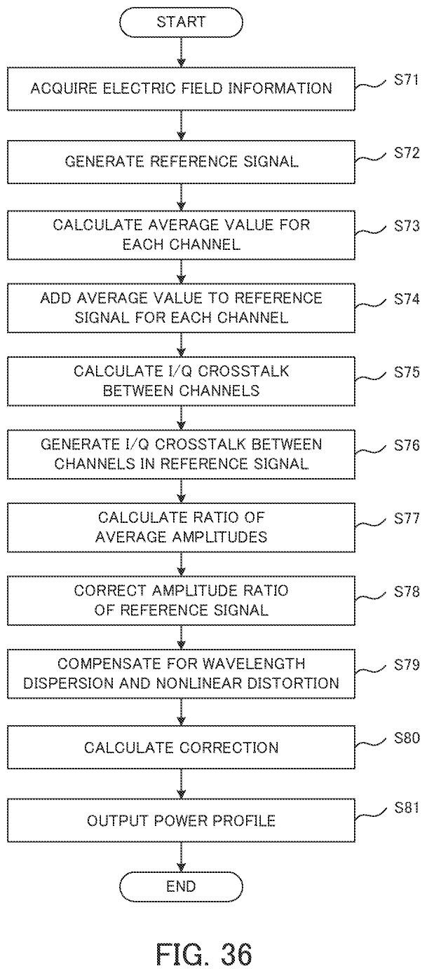

FIG. 35 illustrates configuration examples of the I/Q distortion detector 111 and the I/Q distortion processor 113 of the sixth embodiment. Similarly to the configuration illustrated in FIG. 32, the I/Q distortion detector 111 includes the average calculator 111a, the I/Q crosstalk calculator 111b, and the amplitude ratio calculator 111c. In addition, the I/Q distortion processor 113 includes a bias error processor 113a, a quadrature error processor 113b, and an amplitude error processor 113c. Hereinafter, operations of the I/Q distortion detector 111 and the I/Q distortion processor 113 will be described with reference to a flowchart illustrated in FIG. 36.

FIG. 36 is a flowchart illustrating an example of a process of the optical transmission line monitoring device according to the sixth embodiment. Note that the optical transmission device 20 illustrated in FIG. 34 receives the optical signal transmitted from the transmitter node 10 illustrated in FIG. 1 via the optical fiber transmission line 30.

In S71, the optical transmission line monitoring device 100B acquires a specified number of electric field information signals. S71 is substantially the same as S51 illustrated in FIG. 33. In S72, the transmission waveform reconfiguration unit 105 recovers the transmission symbol from the reception signal and reconfigures the transmission signal from the transmission symbol. This transmission signal is used as the reference signal in the optical transmission line monitoring device 100B.

S73 to S78 correspond to S52 to S57 of FIG. 33 executed in the fifth embodiment. However, in the fifth embodiment, the I/Q distortion compensator 112 compensates for the I/Q distortion of the reception signal. On the other hand, in the sixth embodiment, the I/Q distortion processor 113 performs a process corresponding to the I/Q distortion on the reference signal indicating the transmission signal.

In S73, the average calculator 111a calculates the average value of the electric fields for each of an I channel and a Q channel based on the electric field information signals stored in the capture memory 101. Here, assuming that there is no bias error in the transmitter node 10, the averages of the electric fields of the I channel and the Q channel are each zero. That is, the average value calculated in S73 indicates a deviation from the ideal electric field. Accordingly, in S74, the bias error processor 113a adds the average value to the electric field information of each symbol of the reference signal. Specifically, in each symbol of the reference signal, the average value of the I channel is added to the electric field information of the I channel, and the average value of the Q channel is added to the electric field information of the Q channel. Hence, the bias error in the reference signal becomes substantially the same as the bias error in the reception signal.

In S75, the I/Q crosstalk calculator 111b calculates a I/Q crosstalk of the electric field between the I channel and the Q channel based on the reception signal or the output signal of the bias error processor 113a. In this example, the I/Q crosstalk from the I channel to the Q channel is calculated. The I/Q crosstalk (sin θ) from the I channel to the Q channel is calculated by Formula (1) described above.

In S76, the quadrature error processor 113b generates the electric field leakage calculated by the I/Q crosstalk calculator 111b in the reference signal (specifically, the output signal of the bias error processor 113a). The process of generating the electric field crosstalk is expressed by Formula (5).

$$( \begin{matrix}I \\ Q\end{matrix} ) = ( \begin{matrix}1 & 0 \\ sin θ & cos θ\end{matrix} ) ( \begin{matrix}I \\ Q\end{matrix} ) \qquad ( 5 )$$

In S77, the amplitude ratio calculator 111c calculates the ratio between the average amplitude of the I channel and the average amplitude of the Q channel based on the reception signal or the output signal of the quadrature error processor 113b. A ratio c between the average amplitude of the I channel and the average amplitude of the Q channel is calculated by Formula (3) described above.

In S78, the amplitude error processor 113c adjusts the amplitude of each symbol of the reference signal based on the amplitude ratio obtained in S77. In this example, the amplitude of the Q channel of the reference signal is corrected. In this case, the process of adjusting the amplitude ratio is expressed by Formula (6).

$$( \begin{matrix}I \\ Q\end{matrix} ) = ( \begin{matrix}1 & 0 \\ 0 & \frac{1}{c}\end{matrix} ) ( \begin{matrix}I \\ Q\end{matrix} ) \qquad ( 6 )$$

S79 to S81 are substantially the same as S59 to S61 illustrated in FIG. 33. However, the dispersion/nonlinear compensator 104 compensates for the chromatic dispersion and the nonlinear distortion in the reception signal in which the I/Q distortion is not compensated for. In S80, the correlation calculator 106 calculates a correlation between the output signal (that is, the monitor signal) of the dispersion/nonlinear compensator 104 and the reference signal to which the I/Q distortion is added. Hence, the optical power of the optical fiber transmission line 30 is measured using the reception signal and the reference signal to which the same I/Q distortion is added. Then, in S81, the optical transmission line monitoring device 100B outputs the power profile.

### Seventh Embodiment

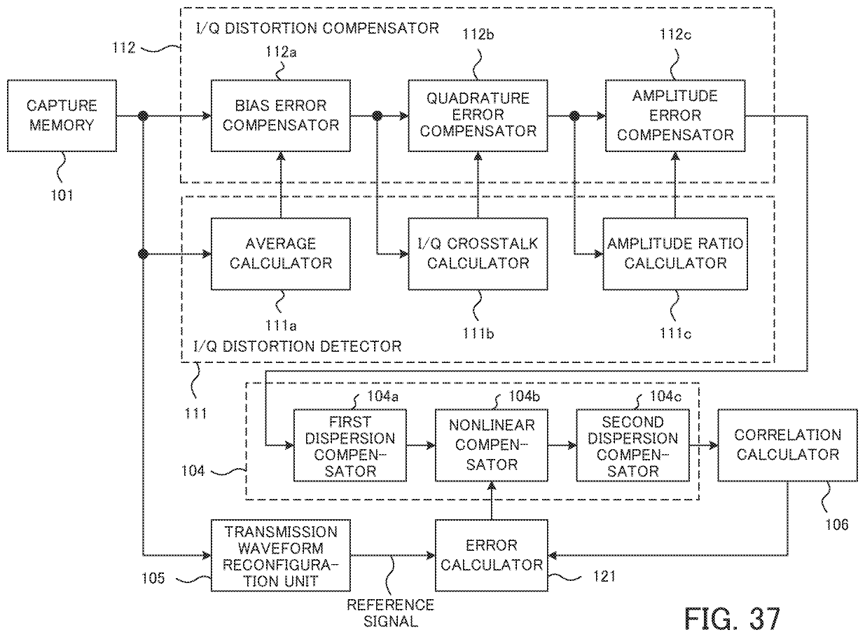

FIG. 37 illustrates an example of an optical transmission line monitoring device according to the seventh embodiment of the present invention. An optical transmission line monitoring device according to the seventh embodiment includes an error calculator 121 in addition to the configuration illustrated in FIG. 32. In addition, the dispersion/nonlinear compensator 104 includes a first dispersion compensator 104a, a nonlinear compensator 104b, and a second dispersion compensator 104c. The first dispersion compensator 104a, the nonlinear compensator 104b, and the second dispersion compensator 104c are substantially the same as the first dispersion compensator 43a, the nonlinear compensator 43b, and the second dispersion compensator 43c illustrated in FIG. 1. Note that, although not illustrated in FIG. 37, similarly to the configuration illustrated in FIG. 32, the correlation calculator 106 calculates a correlation between the output signal of the dispersion/nonlinear compensator 104 and the output signal of the transmission waveform reconfiguration unit 105.

The error calculator 121 calculates the difference between the reference signal generated by the transmission waveform reconfiguration unit 105 and the reception signal whose chromatic dispersion and nonlinear distortion have been compensated for by the dispersion/nonlinear compensator 104. The nonlinear compensator 104b compensates for the nonlinear distortion (that is, self-phase modulation) of the reception signal according to the difference calculated by the error calculator 121. Here, the I/Q distortion of the reception signal is compensated for by the I/Q distortion compensator 112. Thus, when the nonlinear distortion is appropriately compensated for in the dispersion/nonlinear compensator 104, the difference calculated by the error calculator 121 becomes substantially zero. Accordingly, the nonlinear compensator 104b adjusts the compensation amount for compensating for the nonlinear distortion so that the difference calculated by the error calculator 121 approaches zero. Hence, more accurate optical power measurement is achieved.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present inventions have been described in detail, it should be understood that the various changes, substitutions, and alterations could be made hereto without departing from the spirit and scope of the invention.

What is claimed is:

1. An optical transmission line monitoring device that monitors an optical fiber transmission line by using an electric field information signal indicating an electric field of an optical signal received via the optical fiber transmission line by a second node in an optical transmission system in which the optical signal is transmitted from a first node to the second node via the optical fiber transmission line, the optical transmission line monitoring device comprising:
a processor configured to
perform a first process to compensate for, in the electric field information signal, a first chromatic dispersion among a chromatic dispersion of the optical fiber transmission line,
perform a second process to compensate for, in an output signal of the first process, a nonlinear distortion of the optical fiber transmission line,
perform a third process to compensate for, in an output signal of the second process, a remaining chromatic dispersion among the chromatic dispersion of the optical fiber transmission line,
generate, based on the electric field information signal, a reference signal indicating the electric field of the optical signal in the first node,
detect, in the electric field information signal, a second distortion different from the nonlinear distortion compensated for in the second process,
process the reference signal based on the second distortion to generate a second reference signal, and
calculate, based on a correlation between an output signal of the third process and the second reference signal, an optical power corresponding to the first chromatic dispersion.

2. The optical transmission line monitoring device according to claim 1, wherein
the processor shapes a spectrum of the reference signal to generate the second reference signal.

3. The optical transmission line monitoring device according to claim 2, wherein
the processor generates the second reference signal by reducing an amplitude component of the spectrum of the reference signal so as to be similar to a spectrum of the electric field information signal.

4. The optical transmission line monitoring device according to claim 2, wherein
the processor filters the reference signal in a frequency domain according to filter information indicating a characteristic of the optical fiber transmission line to generate the second reference signal.

5. The optical transmission line monitoring device according to claim 2, wherein
the processor filters the reference signal in a frequency domain according to filter information generated based on the electric field information signal to generate the second reference signal.

6. The optical transmission line monitoring device according to claim 2, wherein
the processor performs
a fourth process to filter the reference signal in a frequency domain;
a fifth process to calculate a correlation between an output signal of the fourth process and the electric field information signal in the frequency domain; and
a sixth process to control the fourth process so as to increase the correlation calculated in the fifth process, and
the processor generates the second reference signal based on the output signal of the fourth process when the correlation calculated in the fifth process is maximized.

7. The optical transmission line monitoring device according to claim 1, wherein
the processor generates the reference signal by reconfiguring an electric field of the optical signal at the first node based on transmission data recovered from the electric field information signal.

8. The optical transmission line monitoring device according to claim 1, wherein
the processor calculates a corresponding optical power while changing an amount of the first chromatic dispersion to create a power profile indicating an optical power with respect to a plurality of chromatic dispersion amounts.

9. The optical transmission line monitoring device according to claim 8, wherein
the processor performs
a seventh process to detect one or a plurality of spans constituting the optical fiber transmission line using the power profile,
an eighth process to calculate a dispersion coefficient of the optical fiber transmission line by dividing a chromatic dispersion amount estimated based on the power profile by a corresponding span length for each span detected in the seventh process, and
a ninth process to estimate a type of an optical fiber constituting the optical fiber transmission line based on the dispersion coefficient calculated in the eighth process for each span detected in the seventh process.

10. The optical transmission line monitoring device according to claim 1, wherein
the processor adjusts an I/Q distortion of the reference signal to generate the second reference signal.

11. An optical transmission line monitoring device that monitors an optical fiber transmission line by using an electric field information signal indicating an electric field of an optical signal received via the optical fiber transmission line by a second node in an optical transmission system in which the optical signal is transmitted from a first node to the second node via the optical fiber transmission line, the optical transmission line monitoring device comprising:
a processor configured to
perform a first process to compensate for, in the electric field information signal, a second distortion different from a nonlinear distortion of the optical fiber transmission line,
perform a second process to compensate for, in an output signal of the first process, a first chromatic dispersion among a chromatic dispersion of the optical fiber transmission line,
perform a third process to compensate for, in an output signal of the second process, the nonlinear distortion of the optical fiber transmission line,
perform a fourth process to compensate for, in an output signal of the third process, a remaining chromatic dispersion among the chromatic dispersion of the optical fiber transmission line,
generate, based on the electric field information signal, a reference signal indicating the electric field of the optical signal in the first node, and
calculate, based on a correlation between an output signal of the fourth process and the reference signal, an optical power corresponding to the first chromatic dispersion.

12. The optical transmission line monitoring device according to claim 11, wherein
the processor compensates for an I/Q distortion in the electric field information signal in the first process.

13. An optical transmission line monitoring method that monitors an optical fiber transmission line in an optical transmission system in which an optical signal is transmitted from a first node to a second node via the optical fiber transmission line, the optical transmission line monitoring method comprising:
generating an electric field information signal indicating an electric field of the optical signal received via the optical fiber transmission line by the second node;
generating a second electric field information signal by compensating for, in the electric field information signal, a first chromatic dispersion among a chromatic dispersion of the optical fiber transmission line;
generating a third electric field information signal by compensating for, in the second electric field information signal, a nonlinear distortion of the optical fiber transmission line;
generating a fourth electric field information signal by compensating for, in the third electric field information signal, a remaining chromatic dispersion among the chromatic dispersion of the optical fiber transmission line;
generating, based on the electric field information signal, a reference signal indicating the electric field of the optical signal in the first node;
detecting, in the electric field information signal, a second distortion different from the nonlinear distortion,
processing the reference signal based on the second distortion to generate a second reference signal; and
calculating, based on a correlation between the fourth electric field information signal and the second reference signal, an optical power corresponding to the first chromatic dispersion.

14. An optical transmission line monitoring method that monitors an optical fiber transmission line in an optical transmission system in which an optical signal is transmitted from a first node to a second node via the optical fiber transmission line, the optical transmission line monitoring method comprising:
generating an electric field information signal indicating an electric field of the optical signal received via the optical fiber transmission line by the second node;
generating a distortion-compensated electric field information signal by compensating for, in the electric field information signal, a second distortion different from a nonlinear distortion of the optical fiber transmission line;
generating a second electric field information signal by compensating for, in the distortion-compensated electric field information signal, a first chromatic dispersion among a chromatic dispersion of the optical fiber transmission line;
generating a third electric field information signal by compensating for, in the second electric field information signal, the nonlinear distortion of the optical fiber transmission line;
generating a fourth electric field information signal by compensating for, in the third electric field information signal, a remaining chromatic dispersion among the chromatic dispersion of the optical fiber transmission line;
generating, based on the electric field information signal, a reference signal indicating the electric field of the optical signal in the first node; and
calculating, based on a correlation between the fourth electric field information signal and the reference signal, an optical power corresponding to the first chromatic dispersion.
